(19) United States
(12) Patent Application Publication
(10) Pub. No.: US 2025/0238675 A1
(43) Pub. Date: Jul. 24, 2025

(54) THERMODYNAMIC COMPUTING SYSTEM CONFIGURED TO DETERMINE UPDATED WEIGHTS AND BIASES USING MEASUREMENTS OF ANCILLA OSCILLATORS

(71) Applicant: Extropic Corp., Austin, TX (US)

(72) Inventors: Christopher Chamberland, Austin, TX (US); Guillaume Verdon-Akzam, Montreal (CA)

(73) Assignee: Extropic Corp., Austin, TX (US)

(21) Appl. No.: 18/418,946

(22) Filed: Jan. 22, 2024

(51) Int. Cl. G06N 3/086; G01K 7/42; G06F 17/18; G06N 3/063

(52) U.S. Cl. CPC G06N 3/086; G01K 7/427; G06F 17/18; G06N 3/063

(57) ABSTRACT

A neuro-thermodynamic computer includes a thermodynamic processor chip that includes oscillators that are mapped to neurons and additional oscillators that are mapped to synapses, wherein the synapses correspond to weights and bias values used to describe relationships between the neurons in an energy-based model. The neuro-thermodynamic computer further comprises one or more ancilla thermodynamic chips with ancilla oscillators coupled to the synapse oscillators of the thermodynamic processor chip. Learning algorithms are described for computing gradients for a positive phase term and a negative phase term, as well as elements of an information matrix based on measurements taken of the ancilla oscillators, without a need to fully compute updated weights and biases on classical hardware.

### BACKGROUND

Various algorithms, such as machine learning algorithms, often use statistical probabilities to make decisions or to model systems. Some such learning algorithms may use Bayesian statistics, or may use other statistical models that have a theoretical basis in natural phenomena. Also, machine learning algorithms themselves may be implemented using Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

### BRIEF DESCRIPTION OF THE DRAWINGS

FIG. 1 is high-level diagram illustrating a process of determining weights and biases to be used in a Bayesian algorithm, wherein the weights and biases are determined using measurement values of ancilla oscillators of an ancilla thermodynamic chip that is coupled to a thermodynamic processor chip, and wherein visible neuron oscillators of the thermodynamic chip are used to implement, at least in part, the Bayesian algorithm, according to some embodiments.

FIG. 2A illustrates an example ancilla thermodynamic chip (A3 chip) coupled to a thermodynamic processor chip using momentum-to-position couplings between synapse oscillators of the thermodynamic processor chip and ancilla oscillators of the A3 ancilla thermodynamic chip, according to some embodiments.

FIG. 2B provides additional detail regarding the two-body momentum-to-position couplings between the A3 ancilla thermodynamic chip and the thermodynamic processor chip, according to some embodiments.

FIG. 3A illustrates an example ancilla thermodynamic chip (A1 chip) coupled to a thermodynamic processor chip using momentum-and-force-to-position couplings between sets of synapse oscillators of the thermodynamic processor chip and respective ancilla oscillators of the A1 ancilla thermodynamic chip, according to some embodiments.

FIG. 3B provides additional detail regarding the three-body momentum-and-force-to-position couplings between the sets of synapse oscillators of the thermodynamic processor chip and the respective ancilla oscillators of the A1 ancilla thermodynamic chip, according to some embodiments.

FIG. 4A illustrates an example ancilla thermodynamic chip (A2 chip) coupled to a thermodynamic processor chip using momentum-and-force-to-position couplings between synapse oscillators of the thermodynamic processor chip and ancilla oscillators of the A2 ancilla thermodynamic chip, according to some embodiments.

FIG. 4B provides additional detail regarding the two-body momentum-and-force-to-position couplings between the synapse oscillators of the thermodynamic processor chip and the ancilla oscillators of the A2 ancilla thermodynamic chip, according to some embodiments.

FIG. 5 is a high-level diagram illustrating ancilla oscillator measurements being taken for evolutions of a neuro-thermodynamic processor system comprising a thermodynamic processor chip and an ancilla thermodynamic chip (A3 chip), wherein the visible neuron oscillators of the thermodynamic processor chip are clamped to mini-batches of input training data during evolutions for which a first set of measurements are taken from ancilla oscillator of the ancilla thermodynamic chip (A3 chip), and wherein the visible neuron oscillators of the thermodynamic process chip are left un-clamped during an additional one or more evolutions for which a second set of measurements are taken from the ancilla oscillators of the ancilla thermodynamic chip (A3 chip), according to some embodiments.

FIG. 6 is a high-level diagram illustrating ancilla oscillator measurements being taken for evolutions of a neuro-thermodynamic processor system comprising a thermodynamic processor chip and A1 and A2 ancilla thermodynamic chips, wherein the visible neuron oscillators of the thermodynamic processor chip are clamped to mini-batches of input training data during evolutions for which a first set of measurements are taken using ancilla oscillators of the A2 ancilla thermodynamic chip, wherein the visible neuron oscillators of the thermodynamic processor chip are left un-clamped during another evolution for which other measurements are taken using the ancilla oscillators of the A2 ancilla thermodynamic chip, wherein yet another un-clamped evolution is performed for which additional measurements are taken using the ancilla oscillators of the A1 ancilla thermodynamic chip, according to some embodiments.

FIG. 7A illustrates an example equations for determining gradients that are used in determining updated weights and biases, wherein the gradients are determined using ancilla oscillator measurements results from an A3 ancilla thermodynamic chip and simple addition, subtraction, multiplication, and summation operations performed by a classical computing device, according to some embodiments.

FIG. 7B illustrates an example information matrix that is used in determining updated weight and biases values, for example when using a natural gradient descent technique, wherein the components of the information matrix are determined using ancilla oscillator measurement results from an A3 ancilla thermodynamic chip and simple multiplication and summation operations performed by a classical computing device, according to some embodiments.

FIG. 8A illustrates an example equations for determining gradients that are used in determining updated weights and biases, wherein the gradients are determined using ancilla oscillator measurements of an A2 ancilla thermodynamic chip and simple addition, subtraction, multiplication, and integration operations performed by a classical computing device, according to some embodiments.

FIG. 8B illustrates an example information matrix that is used in determining updated weight and biases values, for example when using a natural gradient descent technique, wherein the components of the information matrix are determined using ancilla oscillator measurement results from A1 and A2 ancilla thermodynamic chips and simple addition, subtraction, multiplication and integration operations performed by a classical computing device, according to some embodiments.

FIG. 9A is an illustrative diagram showing relative masses and motions of ancilla oscillators, synapse oscillators, and neuron oscillators of an ancilla thermodynamic chip and a thermodynamic processor chip at a time T₁ corresponding to an initial portion of an evolution of a neuro-thermodynamic processor system comprising the ancilla thermodynamic chip and the thermodynamic processor chip, according to some embodiments.

FIG. 9B is an illustrative diagram showing the relative masses and motions of the ancilla oscillators, synapse oscillators, and the neuron oscillators of the ancilla thermodynamic chip and the thermodynamic processor chip at a time T₂ corresponding to a point in time in the evolution wherein the neuron oscillators have reached a thermal equilibrium, but the synapse oscillators and ancilla oscillators have not yet reached thermal equilibrium and continue to evolve, according to some embodiments.

FIG. 9C is an illustrative diagram showing the relative masses and motions of the ancilla oscillators, synapse oscillators, and the neuron oscillators of the ancilla thermodynamic chip and the thermodynamic processor chip at a time T₃ corresponding to a point in time in the evolution wherein the neuron oscillators and the synapse oscillators have reached thermal equilibrium, according to some embodiments.

FIG. 10 illustrates an example of momentum measurements being taken of the ancilla oscillators between time T₂ and time T₃, wherein a set of momentum measurements of the ancilla oscillators are taken sequentially close in time to one another shortly after the neuron oscillators have reached thermal equilibrium and another set of momentum measurements of the ancilla oscillators are taken sequentially close in time to one another sometime later, which may be shortly before the synapse oscillators reach thermal equilibrium, according to some embodiments.

FIG. 11 illustrates an example of multiple momentum measurements being taken of the ancilla oscillators between time T₂ (when the neuron oscillators reach thermal equilibrium) and time T₃, according to some embodiments.

FIG. 12 is high-level diagram illustrating an example neuro-thermodynamic processor system comprising an ancilla thermodynamic chip and a thermodynamic processor chip included in a dilution refrigerator and coupled to a classical computing device in an environment external to the dilution refrigerator, according to some embodiments.

FIG. 13 is high-level diagram illustrating an example neuro-thermodynamic processor system comprising an ancilla thermodynamic chip and a thermodynamic processor chip included in a dilution refrigerator and coupled to a classical computing device that is also included in the dilution refrigerator, according to some embodiments.

FIG. 14 is high-level diagram illustrating an example neuro-thermodynamic processor system comprising an ancilla thermodynamic chip and a thermodynamic processor chip coupled to a classical computing device in an environment other than a dilution refrigerator, according to some embodiments.

FIG. 15 is a high-level diagram illustrating oscillators included in a substrate of a thermodynamic chip, such as a thermodynamic processor chip, and a mapping of the oscillators to logical neurons or synapses of the thermodynamic chip, according to some embodiments. Note that a similar substrate may be used for an ancilla thermodynamic chip, however the oscillators of the ancilla thermodynamic chip are coupled to synapse oscillators of a corresponding thermodynamic processor chip, according to some embodiments.

FIG. 16 is an additional high-level diagram illustrating oscillators included in a substrate of the thermodynamic chip mapped to logical neurons, weights, and biases (e.g., synapses) of a neuro-thermodynamic processor system, according to some embodiments.

FIG. 17 illustrates example couplings between visible neurons, weights, and biases (e.g., synapses) of a thermodynamic chip, according to some embodiments.

FIG. 18A illustrates example couplings between visible neurons of a thermodynamic chip, according to some embodiments.

FIG. 18B illustrates example couplings between visible neurons and non-visible neurons (e.g., hidden neurons) of a thermodynamic chip, according to some embodiments.

FIGS. 19A-19C illustrate an example algorithm for learning weights and bias values to be used in a Bayesian algorithm, based on measurements taken of ancilla oscillators of an A3 ancilla thermodynamic chip coupled to a thermodynamic processor chip, according to some embodiments.

FIGS. 20A-20C illustrate an example algorithm for learning weights and bias values to be used in a Bayesian algorithm, based on measurements taken of ancilla oscillators of an A2 ancilla thermodynamic chip and based on measurements taken of ancilla oscillators of an A1 ancilla thermodynamic chip, both respectively coupled to a thermodynamic processor chip, according to some embodiments.

FIG. 21 illustrates a high-level overview of the technique using the A1 and A2 ancilla chips and respective couplings and de-coupling performed when using this technique, according to some embodiments.

FIG. 22 illustrates a high-level overview of the technique using the A3 ancilla chip, according to some embodiments.

FIG. 23 illustrates an example apparatus for measuring positions of oscillators of a thermodynamic chip using a flux read-out device, according to some embodiments.

FIG. 24 illustrates an example apparatus for measuring momentums of oscillators of a thermodynamic chip using a charge read-out device, according to some embodiments.

FIG. 25 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems, and an apparatus for performing computer operations using a neuro-thermodynamic processor system comprising a thermodynamic processor chip and one or more ancilla thermodynamic chips. In some embodiments, a neuro-thermodynamic processor system may be configured such that learning algorithms for learning parameters of an energy-based model may be applied using Langevin dynamics. For example, as described herein, a neuro-thermodynamic processor system may be configured such that, given a Hamiltonian that describes the energy-based model, weights and biases (e.g., synapses) may be calculated based on measurements taken from an ancilla thermodynamic chip coupled to a thermodynamic processor chip as the neuro-thermodynamic processor system (comprising the thermodynamic processor chip and the ancilla thermodynamic chip) naturally evolves according to Langevin dynamics. For example, a positive phase term, a negative phase term, associated gradients, and elements of an information matrix needed to determine updated weights and biases for the energy-based model may be simply computed on an accompanying classical computing device, such as a field programmable gate array (FPGA) or application specific integrated circuit (ASIC), based on measurements taken from the ancilla oscillators of the ancilla thermodynamic chip. Such calculations performed on the accompanying classical computing device may be simple and non-complex as compared to other approaches that use the classical computing device to determine statistical probabilities (e.g., without using a thermodynamic processor chip or an ancilla thermodynamic chip). For example, a natural gradient descent technique for learning parameters of a machine model, implemented using a neuro-thermodynamic processor system, may be learned using ancilla oscillator measurements and non-complex calculations performed on a classical computing device. As described herein, non-complex calculations may include addition, subtraction, multiplication, division, summation, and/or integration over time (e.g. of measured values), etc. and may avoid more complex calculations, such as statistical probability calculations, typically used in other approaches for performing Bayesian learning.

More particularly, physical elements of a thermodynamic chip may be used to physically model evolution according to Langevin dynamics. For example, in some embodiments, a thermodynamic chip includes a substrate comprising oscillators implemented using superconducting flux elements. For thermodynamic chips used as thermodynamic processors, the oscillators may be mapped to neurons (visible or hidden) that “evolve” according to Langevin dynamics. For example, the oscillators of a thermodynamic processor chip and the oscillators of an ancilla thermodynamic chip may be initialized in a particular configuration and allowed to thermodynamically evolve. The oscillators of a first thermodynamic chip (e.g. the thermodynamic processor chip) may be coupled to oscillators of a second thermodynamic chip (e.g. the ancilla thermodynamic chip). Various couplings between the synapse oscillators of the first thermodynamic chip and the ancilla oscillators of the second thermodynamic chip, may be used. For example, a two-body coupling between an ancilla oscillator and a synapse oscillator may be used, wherein the two-body coupling couples a momentum degree of freedom of the synapse oscillator to a position degree of freedom of the ancilla oscillator. Also, a two-body coupling that couples momentum and force degrees of freedom of a synapse oscillator to a position degree of freedom of an ancilla oscillator may be used. In some embodiments, a three-body coupling may be used wherein two synapse oscillators are coupled to an ancilla oscillator. In some embodiments, the respective couplings in the three-body coupling may be such that force and momentum degrees of freedom of both of the synapse oscillators are coupled to a position degree of freedom of the ancilla oscillator.

As the oscillators of the thermodynamic processor chip and the ancilla thermodynamic chip(s) “evolve”, degrees of freedom of the ancilla oscillators may be sampled. Values of these sampled degrees of freedom may represent, for example, vector values that encode information about corresponding neurons or synapses of the thermodynamic processor chip that evolve according to Langevin dynamics. For example, algorithms that use stochastic gradient optimization and require sampling during training, such as those proposed by Welling and Teh, and/or other algorithms, such as natural gradient descent, mirror descent, etc. may be implemented using a neuro-thermodynamic processor system. In some embodiments, a neuron-thermodynamic processor system may enable such algorithms to be implemented directly by sampling ancillas (e.g., degrees of freedom of the oscillators of the substrate of ancilla thermodynamic chip) without having to calculate statistics to determine probabilities. As another example, neuro-thermodynamic processor systems may be used to perform autocomplete tasks, such as those that use Hopfield networks, which may be implemented using natural gradient descent. For example, visible neurons may be arranged in a fully connected graph (such as a Hopfield network, etc.), and the values of the auto complete task may be learned using a natural gradient descent algorithm.

In some embodiments, a thermodynamic chip includes superconducting flux elements arranged in a substrate, wherein the thermodynamic chip is configured to modify magnetic fields that couple respective ones of the oscillators with other ones of the oscillators. In some embodiments, non-linear (e.g., anharmonic) oscillators are used that have dual-well potentials. These dual-well oscillators may be mapped to neurons of a given energy-based model that the thermodynamic chip is being used to implement. Also, in some embodiments, at least some of the oscillators may be harmonic oscillators with single-well potentials. In some embodiments, oscillators of an ancilla thermodynamic chip may be implemented using either single-well or dual well oscillators. Also, in some embodiments, oscillators may be implemented using superconducting flux elements with varying amounts of non-linearity. In some embodiments, an oscillator may have a single well potential, a dual-well potential, or a potential somewhere in a range between a single-well potential and a dual-well potential. In some embodiments, visible neurons may be mapped to oscillators having a single well potential, a dual-well potential, or a potential somewhere in a range between a single-well potential and a dual-well potential.

In some embodiments, oscillators of a thermodynamic chip may also be used to represent values of weights and biases of an energy-based model. Thus, weights and biases that describe relationships between neurons may also be represented as dynamical degrees of freedom, e.g., using oscillators of a thermodynamic chip (e.g., synapse oscillators of a thermodynamic processor chip).

In some embodiments, parameters of an energy-based model or other learning algorithm may be learned through evolution of the oscillators of a thermodynamic processor chip coupled to an ancilla thermodynamic chip.

As mentioned above, in some embodiments, the weights and biases of an energy-based model are dynamical degrees of freedom (e.g., oscillators of a thermodynamic processor chip), in addition to neurons (hidden or visible) being dynamic degrees of freedom (e.g., represented by other oscillators of the thermodynamic processor chip). In such configurations, gradients needed for learning algorithms can be obtained by performing measurements of ancilla oscillators coupled to the synapse oscillators, such as momentum measurements. For example, momentum measurements of the ancilla oscillators coupled to the synapse oscillators performed on a time scale proportional to a thermalization time of the synapse oscillators, or on shorter time scales than the thermalization times of the synapse oscillators, can be used to compute time-averaged gradients. In some embodiments, the variance of the time average gradient (determined using ancilla oscillator measurements) scales as 1/t where t is the total measurement time. Also, expectation values for an information matrix may be calculated based on the momentum measurements of the ancilla oscillators. For example, the information matrix may be used in natural gradient descent to guide the search for updated weight and bias values. In some embodiments, the expectation values of the information matrix may provide respective measures of how much information a parameter used to determine the weights and biases carries with regard to a distribution that models at least a portion of the energy-based model. These gradients, along with the determined information matrix, can be used to calculate new weights and bias values that may be used as synapse values in an updated version of the energy-based model. The process of making measurements of ancilla oscillators and determining updated weights and biases may be repeated multiple times until a learning threshold for the energy-based model has been reached.

For example, there are various learning algorithms where one must use both positive and negative phase terms to perform parameter updates. For instance, in the implementation by Welling and Teh the parameters are updated as follows:

$${θ}_{t + 1} = {θ}_{t} + \frac{{ϵ}_{t}}{2} ( - {∇}_{{θ}_{t}} {ℰ}_{p} ( {θ}_{t} ) ) - N ( \frac{1}{n} {\sum }_{i = 1}^{n} {∇}_{{θ}_{t}} ℰ ( {θ}_{t} , {x}_{{t}_{i}} ) - {𝔼}_{x ∼ {p}_{{θ}_{t}} ( x )} [ {∇}_{{θ}_{t}} ℰ ( {θ}_{t} , x ) ] ) + {η}_{t}$$

where εₚ(θₜ) is some prior potential and the probability distribution for an energy-based model (EBM) with parameters θₜ given by pθₜ(x)=e^{-ε(θ}^{_{t,}}^{x)}/Z, where Z is a partition function. In the above equation, the first gradient term, where the visible nodes are clamped to the data will be referred to as the positive phase term. The second gradient term, where the visible nodes are sampled from x˜˜pθₜ(x) will be referred to as the negative phase term (e.g., where the visible nodes are unclamped). When hidden neurons are present, the parameter update rule is given by:

$${θ}_{t + 1} = {θ}_{t} + \frac{{ϵ}_{t}}{2} ( - {∇}_{{θ}_{t}} {ℰ}_{p} ( {θ}_{t} ) ) - N ( \frac{1}{n} {\sum }_{i = 1}^{n} {𝔼}_{z ∼ {p}_{{θ}_{t}} ( z \vert {x}_{{t}_{i}} )} [ {∇}_{{θ}_{t}} ℰ ( {θ}_{t} , {x}_{{t}_{i}} , z ) ] - {𝔼}_{( x , z ) ∼ {p}_{{θ}_{t}} ( x , z )} [ {∇}_{{θ}_{t}} ℰ ( {θ}_{t} , x , z ) ] ) + {η}_{t}$$

Similar update rules are also found in natural gradient descent, wherein an information matrix is used in addition to the gradient terms. For example, in natural gradient descent, parameters may be updated using the following equation:

$${θ}_{t + 1} = {θ}_{t} + \frac{1}{{λ}_{t}} {I}^{+} ( {θ}_{t} ) ( - {∇}_{θ} {ℰ}_{p} ( {θ}_{t} ) - N ( \frac{1}{n} {\sum }_{i = 1}^{n} {∇}_{{θ}_{t}} ℰ ( {θ}_{t} , {x}_{{t}_{i}} ) - {𝔼}_{( x ) ∼ {p}_{{θ}_{t}} ( x )} [ {∇}_{{θ}_{t}} ℰ ( {θ}_{t} , x ) ] ) )$$

where λₜ is a learning rate and I⁺(θ) is the Moore-Penrose pseudo inverse of the information matrix I(θ). In some embodiments, expectation values included in the information matrix can be calculated using the Bogoliubov-Kubo-Mori (BKM) metric (denoted I^{BKM}(Q)), which is a special choice of the metric I(θ). For example, the BKM metric for energy-based models (such as those implemented using one or more thermodynamic chips, as described herein) is defined as:

$${{I}^{B K M} ( θ )}_{j , k} = \int ( {\partial }_{{θ}_{j}} , {p}_{θ} ( x ) ) ( {\partial }_{{θ}_{k}} log {p}_{θ} ( x ) )$$

where p_{θ}(x)=exp(−ε_{θ}(x)/Z(θ). Also, using the definition (just given) for p_{θ}(x), the terms in the BKM metric equation can be calculated where the first term is given by:

$${\partial }_{{θ}_{j}} , {p}_{θ} ( x ) = ( {𝔼}_{( z ) ∼ {p}_{θ} ( z )} [ {\partial }_{{θ}_{j}} {ℰ}_{θ} ( z ) ] - {\partial }_{{θ}_{j}} , {ℰ}_{θ} ( x ) ) {p}_{θ} ( x )$$

and the second term is given by:

$${\partial }_{{θ}_{k}} log {p}_{θ} ( x ) = ( - {\partial }_{{θ}_{k}} , {ℰ}_{θ} ( x ) + {𝔼}_{( y ) ∼ {p}_{θ} ( y )} [ {\partial }_{{θ}_{k}} {ℰ}_{θ} ( y ) ] ) .$$

With the first and second terms of the BKM metric equation calculated as described above, the BKM metric can be rewritten as:

$${{I}^{B K M} ( θ )}_{j , k} = {𝔼}_{( x ) ∼ {p}_{θ} ( x )} [ {\partial }_{{θ}_{j}} {ℰ}_{θ} ( x ) {\partial }_{{θ}_{k}} {ℰ}_{θ} ( x ) ] - {𝔼}_{( x ) ∼ {p}_{θ} ( x )} [ {\partial }_{{θ}_{j}} {ℰ}_{θ} ( x ) ] {𝔼}_{( y ) ∼ {p}_{θ} ( y )} [ {\partial }_{{θ}_{k}} {ℰ}_{θ} ( y ) ] .$$

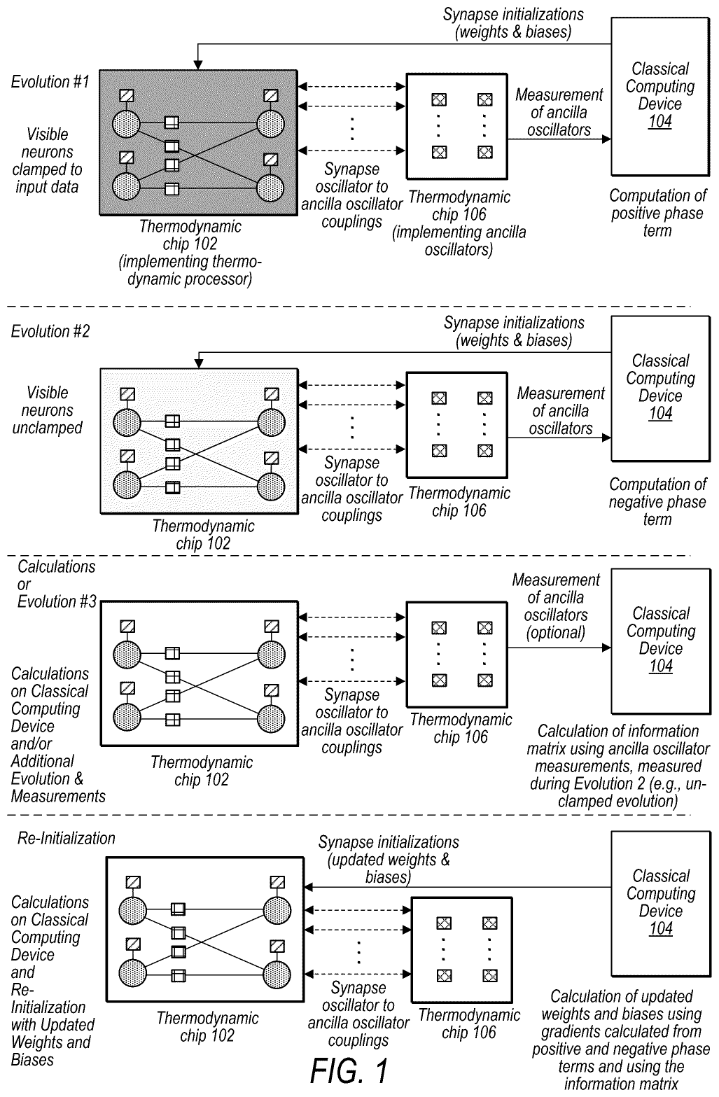

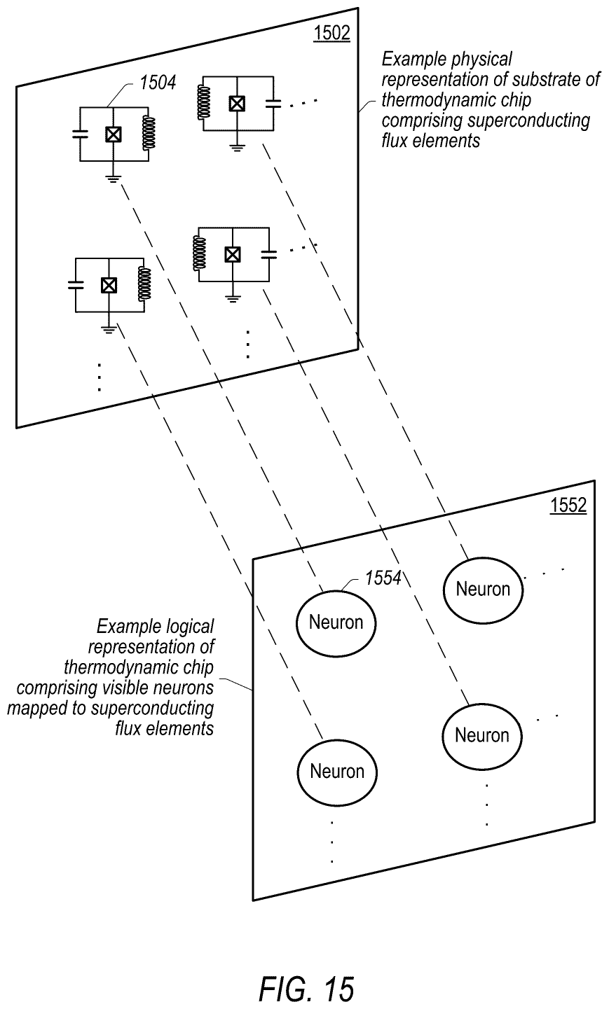

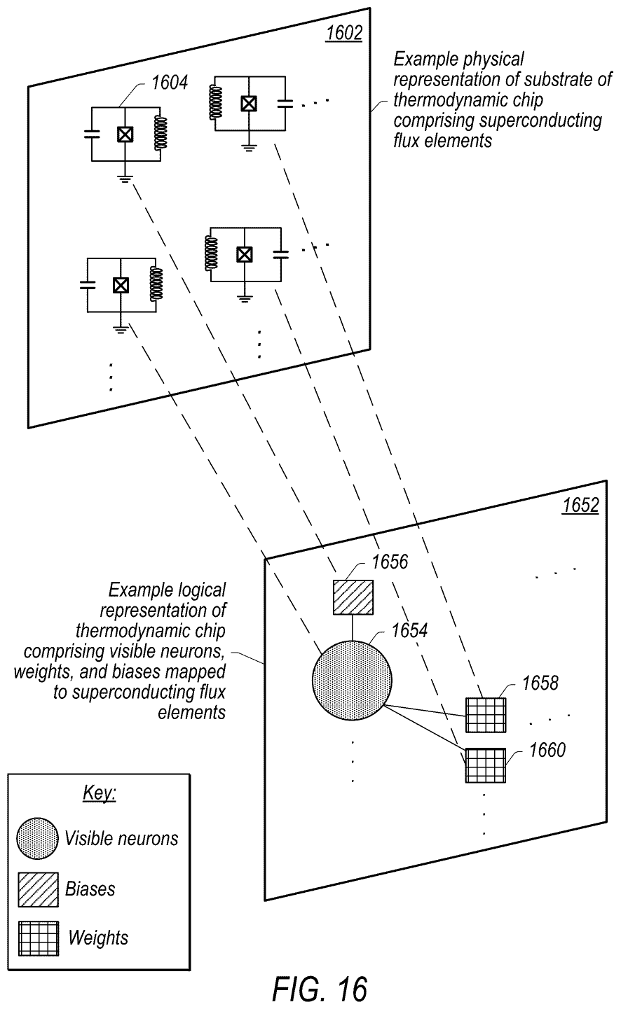

For a neuro-thermodynamic processor chip, such as thermodynamic chip 102 shown in FIG. 1 and also shown in more detail in FIGS. 15-16, which includes visible neurons coupled via weights and biases that are also represented by degrees of freedom (e.g., synapse oscillators), the dynamics of the system for a three-body coupling between the synapse oscillators and the neuron oscillators (visible or hidden) are described by the following Hamiltonian:

$${H}_{total} = {\sum }_{j ∈ {𝒱}_{v i s}} ( \frac{{p}_{j}^{2}}{2 {m}_{j}^{( n )}} + {{E}_{L}^{( n )} ( {q}_{j}^{( n )} - {\tilde{φ}}_{L}^{( n )} )}^{2} + {E}_{J 0}^{( n )} cos ( {\tilde{φ}}_{D C}^{( n )} / 2 ) ( 1 - cos ( {q}_{j}^{( n )} ) ) ) + {\sum }_{k , l ∈ ℰ} ( \frac{{p}_{{s}_{j}}^{2}}{2 {m}_{{s}_{k , l}}^{( w )}} + {{E}_{L}^{( w )} ( {q}_{{s}_{k , l}} - {\tilde{φ}}_{L}^{( w )} )}^{2} + {E}_{J 0}^{( w )} cos ( {\tilde{φ}}_{D C}^{( w )} / 2 ) ( 1 - cos ( {q}_{{s}_{k , l}}^{( w )} ) ) ) + {\sum }_{j ∈ {𝒱}_{v i s}} ( \frac{{p}_{{b}_{j}}^{2}}{2 {m}_{j}^{( b )}} + {{E}_{L}^{( b )} ( {q}_{j}^{( b )} - {\tilde{φ}}_{L}^{( b )} )}^{2} + {E}_{J 0}^{( b )} cos ( {\tilde{φ}}_{D C}^{( b )} / 2 ) ( 1 - cos ( {q}_{j}^{( b )} ) ) ) + ( α {\sum }_{\{ k , l \} ∈ ℰ} {q}_{{s}_{k , l}}^{( s )} {q}_{k}^{( n )} {q}_{l}^{( n )} + β {\sum }_{j ∈ 𝒱} {q}_{j}^{( n )} {q}_{j}^{( s )} ) .$$

Note that the above Hamiltonian uses a representation of couplings between neuron oscillators and synapse oscillators given by the terms proportional to alpha and beta. However, in some embodiments, a Hamiltonian with more general terms may be used. The above Hamiltonian is given as an example of an energy-based model, but others may be used within the scope of the present disclosure. Also note that the superscripts (s) and (n) are used to distinguish between neuron and synapse degrees of freedom. Also, note that the superscripts (w) and (b) are used to distinguish between weights and biases.

In some embodiments, the neurons used to encode the input data are based on a flux qubit design, wherein neurons are described by a phase/flux degree of freedom and the design is based on the DC SQUID (direct current superconducting quantum interference device) which contains two junctions. In the above Hamiltonian, Eⱼ denotes the Josephson energy, L corresponds to the inductance of the main loop, and results in the inductive energy E_{L}. Also, \tilde{φ}_{L} represents the external flux coupled to the main loop and \tilde{φ}_{DC} is the external flux coupled into the DC SQUID loop. Since the visible neurons, as well as the weights/biases, all evolve according to Langevin dynamics, their equations of motion can be written as:

$$\frac{d {q}_{k} ( t )}{d t} = \frac{\partial {H}_{t o t a l}}{\partial {p}_{k}}$$

$${\frac{d {p}_{k} ( t )}{dt} = - γ {p}_{k} ( t ) - \frac{\partial {H}_{t o t a l}}{\partial {q}_{k}} \vert}_{t} + \sqrt{2 {m}_{k} γ {k}_{B} T} \frac{d {W}_{t}}{dt} .$$

where qₖ is used to label the k′th element of the position vector, and pₖ is used to label the k′th element of the momentum vector. Also, as used herein superscripts may be used to distinguish positions (or momentums or forces) of neurons, weights and biases. For example, as qₖ⁽ⁿ⁾ (neurons), qₖ^{(w)} (weights), and qₖ^{(b)} biases). Also, as used below γ is used to label friction, mₖ denotes the mass of a given neuron degree of freedom, such as a mass of a weight degree of freedom, or mass of a bias degree of freedom, and k_{B}T corresponds to the Boltzmann's constant times the temperature of the neuro-thermodynamic system. Also, Wₜ represents a Wienner process.

In some embodiments, momentum measurements of the ancilla oscillators may be used to obtain time averaged gradients, such as for the clamped phase and the un-clamped phase, wherein the visible neuron oscillators are clamped to input data during the clamped phase, and wherein the visible neurons are not clamped to input data during the un-clamped phase, respectively. The protocols described herein can also be used in configurations that include hidden neurons. In systems wherein the visible (or hidden) neuron oscillators have smaller masses than the synapse oscillators, the visible (or hidden) neurons reach thermal equilibrium at a faster time scale than is required for the ancilla oscillators and the synapse oscillators to reach thermal equilibrium. Also, the ancilla oscillators may be selected to have larger masses than the synapse oscillators. In such configurations, the Langevin equations for the ancilla-synapse system can be written as follows, when the A1 ancilla thermodynamic chip is coupled to the thermodynamic processor chip:

$${H}_{a ncilla}^{( 1 )} = {\sum }_{j ∈ {v}_{ancilla}} \frac{{( {p}_{j}^{( a )} )}^{2}}{2 {m}_{j}^{( a )}} - {λ}_{a} {\sum }_{\{ k , l \} ∈ ε} {q}_{skl}^{( a )} ( \frac{d {p}_{k}^{( s )}}{d t} + γ {p}_{k}^{( s )} ) ( \frac{d {p}_{l}^{( s )}}{d t} + γ {p}_{l}^{( s )} )$$

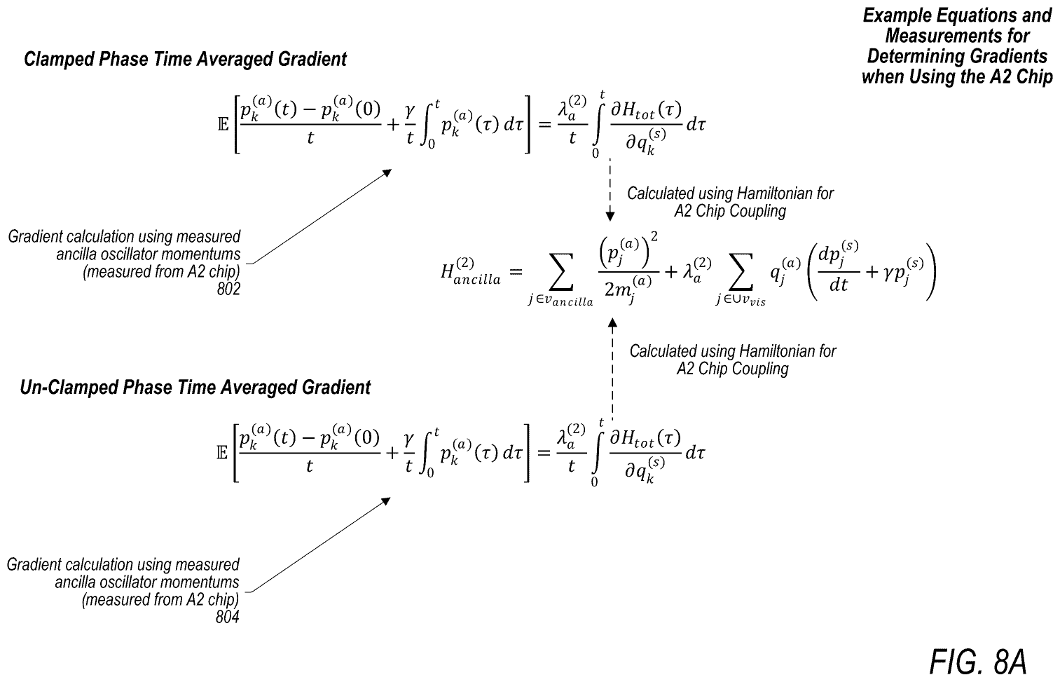

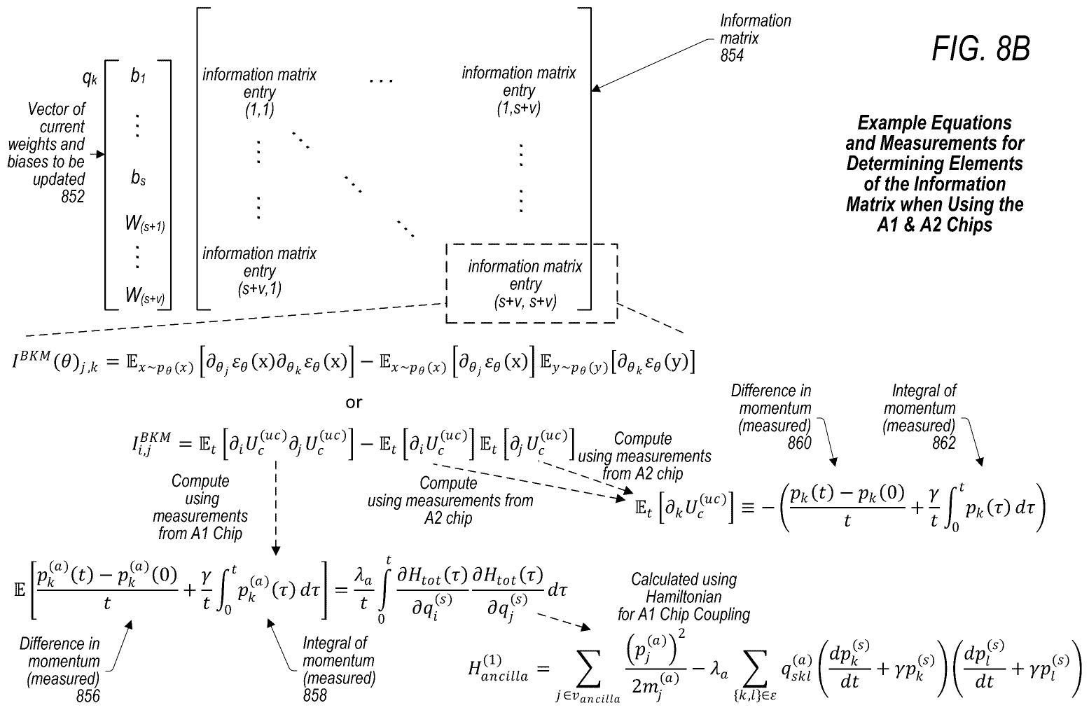

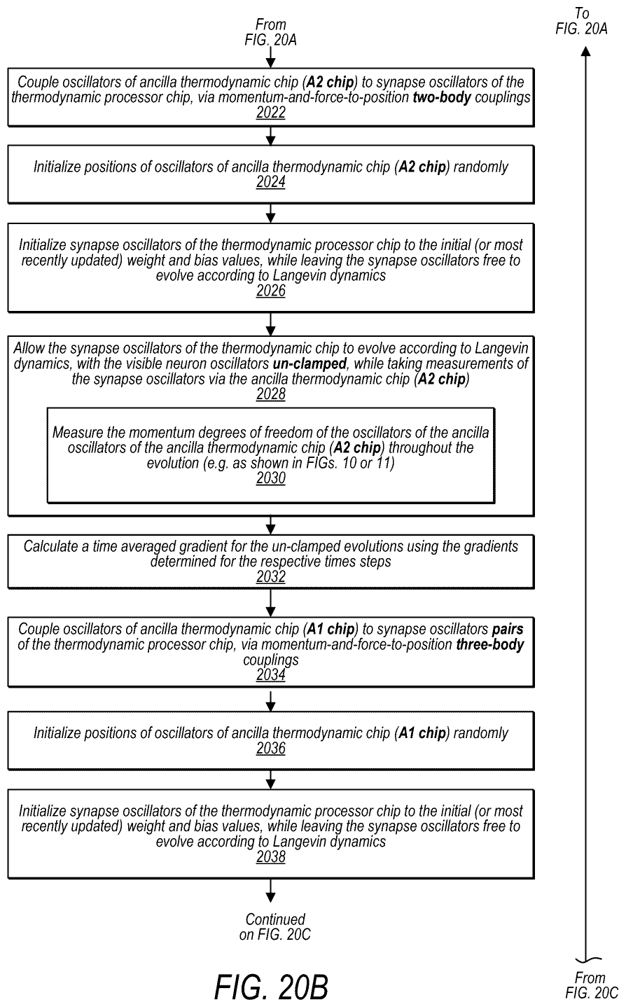

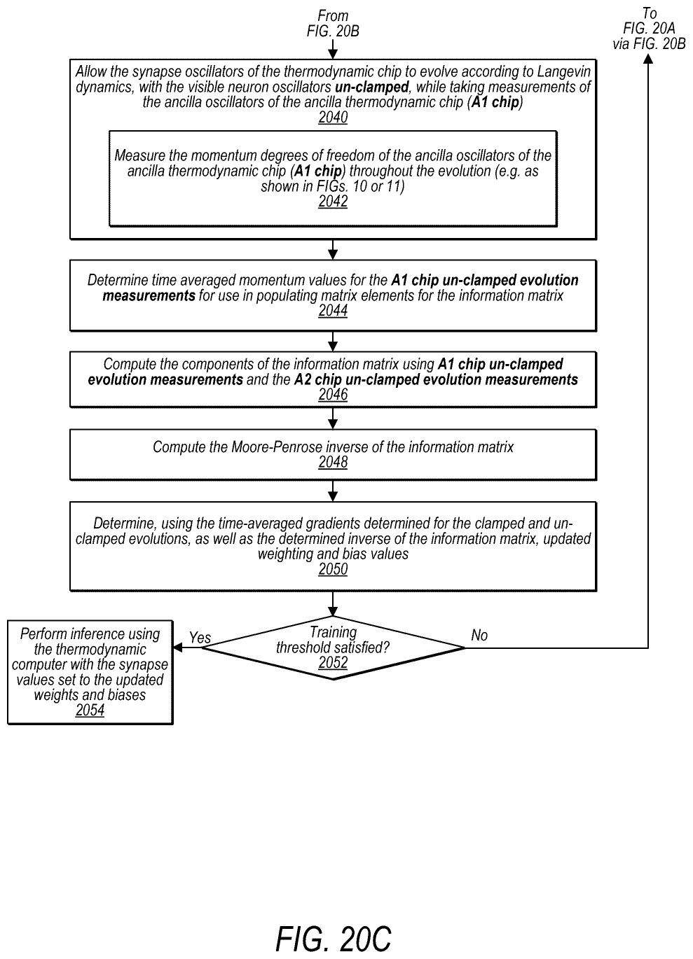

Note that the superscripts (a) and (s) are added to distinguish between the ancilla degrees of freedom and the synapse degrees of freedom. Note that this is the Hamiltonian for the coupling with the A1 ancilla thermodynamic chip as used in the protocol described in FIGS. 20A-20C and in the example calculations shown in FIG. 8B. Using the equation for momentum as discussed previously, the equation for the momentum degree of freedom of the ancilla oscillators of the A1 chip is given by:

$$\frac{d {p}_{k}^{( a )} ( t )}{d t} + γ {p}_{k}^{( a )} ( t ) = {λ}_{a} ( \frac{d {p}_{i}^{( s )}}{d t} + γ {p}_{i}^{( s )} ) ( \frac{d {p}_{j}^{( s )}}{d t} + γ {p}_{j}^{( s )} ) + \sqrt{2 {m}_{k}^{( a )} γ {k}_{B} T \frac{d {W}_{t}^{( k )}}{d t}}$$

where the indices i and j are the indices of the synapses to which the ancilla k is coupled. This equation can further be simplified by using the momentum equation for the synapse degree of freedom, which results in:

$$𝔼 [ \frac{{p}_{k}^{( a )} ( t ) - {p}_{k}^{( a )} ( 0 )}{t} + \frac{γ}{t} {\int }_{0}^{t} {p}_{k}^{( a )} ( τ ) d τ ] = \frac{{λ}_{a}}{t} {\int }_{0}^{t} \frac{\partial {H}_{tot} ( τ )}{\partial {q}_{i}^{( s )}} \frac{\partial {H}_{tot} ( τ )}{\partial {q}_{j}^{( s )}} d τ$$

This equation is also shown in FIG. 8B, which explains how it is used to calculate the first term in the information matrix when using the protocol that uses the A1 and A2 ancilla chips.

For the approach using the A1 and A2 ancilla thermodynamic chips (e.g. the protocol shown in FIGS. 20A-20C and FIGS. 8A and 8B), when the A2 ancilla thermodynamic chip is coupled to the thermodynamic processor chip, the system Hamiltonian is given as follows:

$${H}_{a ncilla}^{( 2 )} = {\sum }_{j ∈ {v}_{a n c i l l a}} \frac{{( {p}_{j}^{( a )} )}^{2}}{2 {m}_{j}^{( a )}} + {λ}_{a}^{( 2 )} {\sum }_{j ∈ ⋃ {v}_{v i s}} {q}_{j}^{( a )} ( \frac{d {p}_{j}^{( s )}}{d t} + γ {p}_{j}^{( s )} )$$

This equation can also further be simplified by using the momentum equation for the synapse degree of freedom, which results in the following:

$$𝔼 [ \frac{{p}_{k}^{( a )} ( t ) - {p}_{k}^{( a )} ( 0 )}{t} + \frac{γ}{t} {\int }_{0}^{t} {p}_{k}^{( a )} ( τ ) d τ ] = \frac{{λ}_{a}^{( 2 )}}{t} {\int }_{0}^{t} \frac{\partial {H}_{tot} ( τ )}{\partial {q}_{k}^{( s )}} d τ$$

These simplified equations allow for determining time averaged gradients used in natural gradient descent by measuring ancilla oscillator momentums of the A2 ancilla thermodynamic chip and of the A1 ancilla thermodynamic chip and performing simple calculations on a classical computing device.

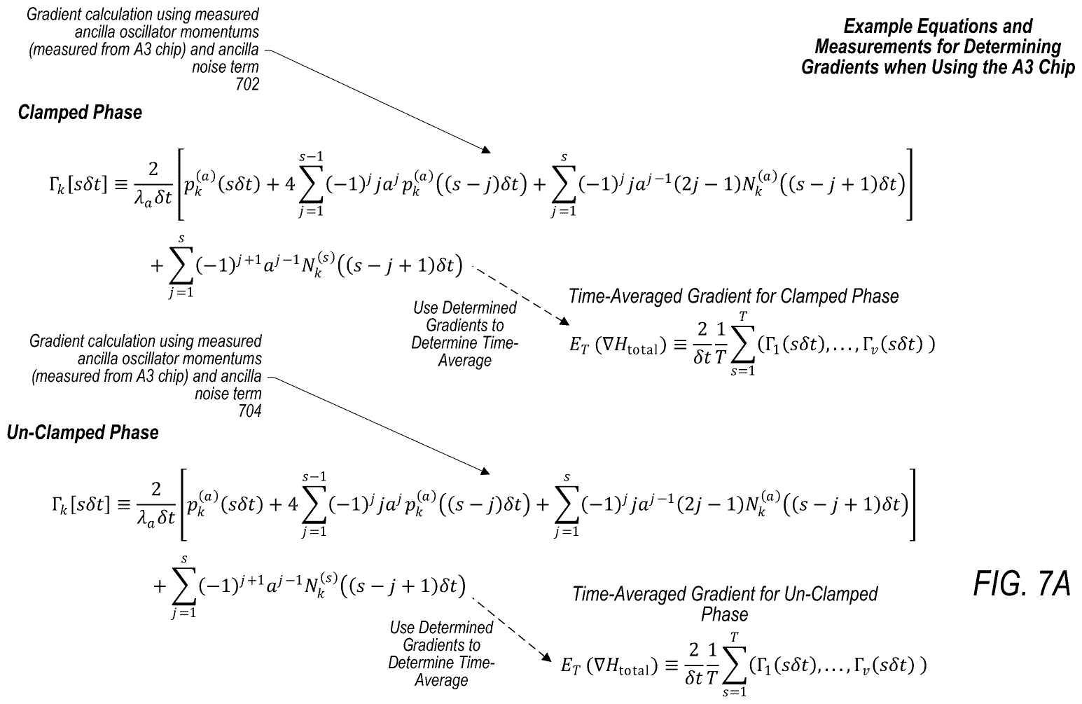

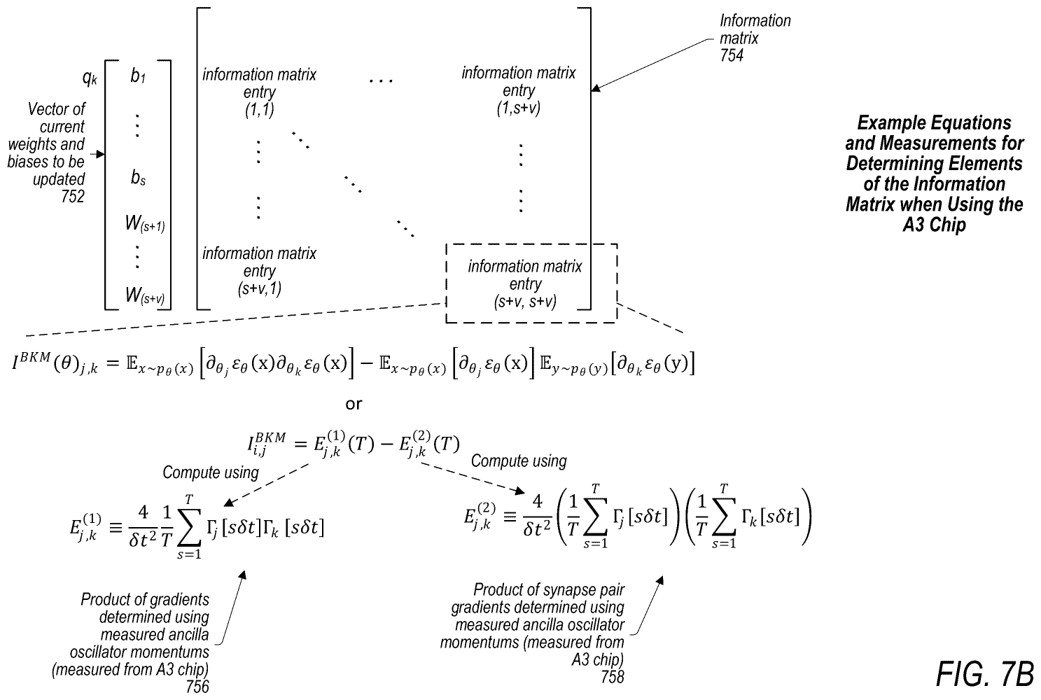

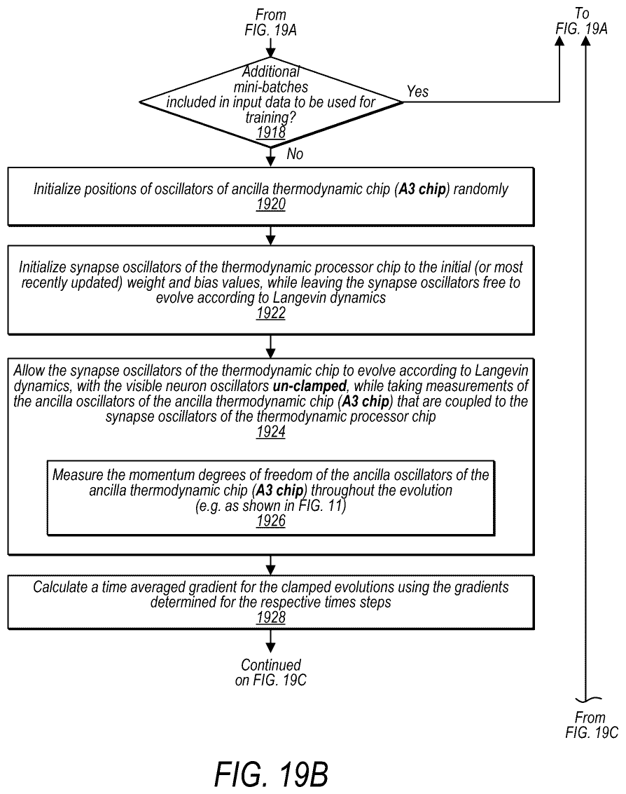

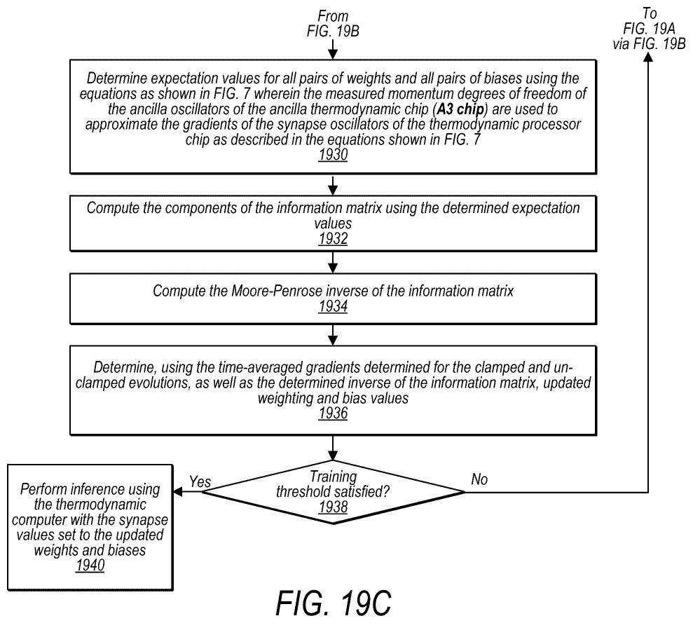

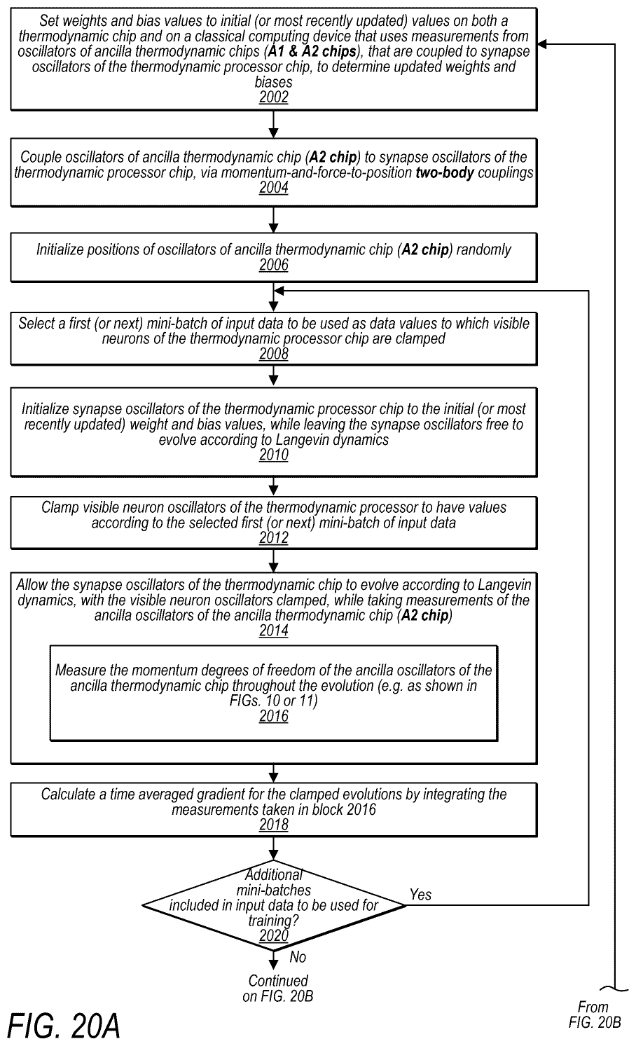

An alternative approach is to use a single ancilla thermodynamic chip, such as the A3 chip. Protocols for this alternative approach are shown in FIGS. 19A-29C and corresponding equations used in this alternative approach are shown in FIGS. 7A and 7B. For the neuro-thermodynamic system implemented using the A3 chip coupled to a thermodynamic processor chip, the system Hamiltonian is given by:

$${H}_{ancilla}^{( 3 )} = {\sum }_{j ∈ {v}_{a ncilla}} \frac{{( {p}_{j}^{( a )} )}^{2}}{2 {m}_{j}^{( a )}} + {λ}_{a} {\sum }_{j ∈ ⋃ {v}_{v i s}} {q}_{j}^{( a )} {p}_{j}^{( s )}$$

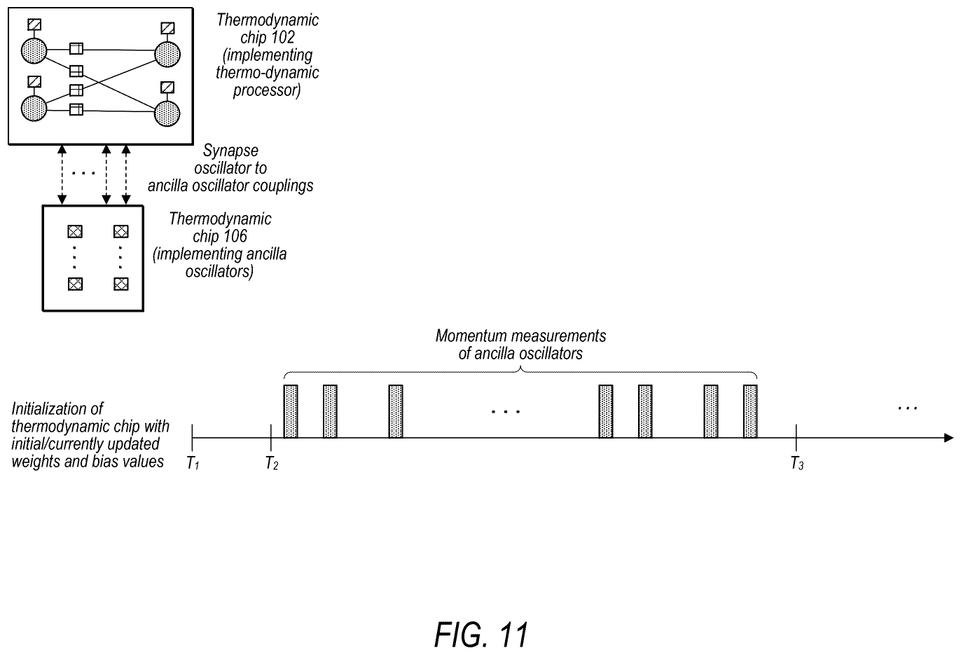

If it is assumed that measurements of the ancilla oscillators of the A3 chip can be repeatedly taken at small time intervals (e.g., of size δt) (such as shown in FIG. 11), position and momentum updates can be given by:

$${q}_{k} ( t + δ t ) = {q}_{k} ( t ) + b δ t \frac{\partial H}{\partial {p}_{k}} {\vert}_{t} - \frac{{b ( δ C )}^{2}}{2 {m}_{k}} \frac{\partial H}{\partial {q}_{k}} {\vert}_{t} + \frac{b {σ ( δ t )}^{3 / 2}}{2 \sqrt{{m}_{k}}} {η}_{t}^{( k )} \qquad ( Position )$$

$${p}_{k} ( t + δ t ) = a {p}_{k} ( t ) - \frac{δ t}{2} ( a \frac{\partial H}{\partial {q}_{k}} {\vert}_{t} + \frac{\partial H}{\partial {q}_{k}} {{\vert}_{t}}_{+ δ t} ) + b σ \sqrt{{m}_{k} δ t {η}_{t}^{( k )}} \qquad ( Momentum )$$

$$where :$$

$$σ = \sqrt{2 {k}_{b} T γ} ;$$

$${η}_{t}^{( k )} ∼ N ( 0 , 1 ) ;$$

$$a ≡ \frac{1 - γδ t / 2}{1 + γδ t / 2} ; and$$

$$b ≡ \frac{1}{1 + γδ t / 2}$$

Combining the Hamiltonian for neuro-thermodynamic processor system comprising the A3 ancilla thermodynamic chip and thermodynamic chip with the momentum equation, the momentum update equation for the ancilla oscillators of the A3 chip can be given by:

$${p}_{k}^{( a )} ( t + δ t ) = a {p}_{k}^{( a )} ( t ) - \frac{{λ}_{a} δ t}{2} ( a {p}_{k}^{( s )} ( t ) + {p}_{k}^{( a )} ( t + δ t ) ) + b σ \sqrt{{m}_{k}^{( a )} δ t {η}_{t}^{( k )}}$$

Also, the momentum of the synapse oscillators of the thermodynamic processor chip coupled to the A3 chip (as well as their desired gradients) can be written in terms of the measured momentums of the ancilla oscillators of the A3 ancilla thermodynamic chip. However, to simplify the notation, the noise of the synapse oscillators and the ancilla oscillators can be written as follows:

$${N}_{k}^{( s )} ( t ) = b σ \sqrt{{m}_{k}^{( s )} δ t {η}_{t}^{( k )}}$$

$${N}_{k}^{( a )} ( t ) = b σ \sqrt{{m}_{k}^{( a )} δ t {η}_{t}^{( k )}}$$

Now by applying the momentum update equation for the ancillas into the momentum equation, it yields:

$${p}_{k}^{( a )} ( t + δ t ) = a {p}_{k}^{( a )} ( t ) - \frac{{λ}_{a} δ t}{2} ( 2 a {p}_{S} ( t ) - \frac{δ t}{2} ( a \frac{\partial {H}_{tot}}{\partial {q}_{k}^{( s )}} {\vert}_{t} + \frac{\partial {H}_{tot}}{\partial {q}_{k}^{( s )}} {{\vert}_{t}}_{+ δ t} + {N}_{k}^{( s )} ( t ) ) ) + {N}_{k}^{( a )} ( t )$$

To simplify the equation, the momentum of the ancillas and synapses can be initialized to zero, however this is not required. Given these initial conditions,

$$\frac{δ t}{2} \frac{\partial {H}_{tot}}{\partial {q}_{k}^{( s )}} {\vert}_{δ t} = \frac{2}{{λ}_{a} δ t} ( {p}_{k}^{( a )} ( δ t ) - {N}_{k}^{( a )} ( δ t ) ) + {N}_{k}^{( s )} ( δ t )$$

$${p}_{s} ( δ t ) = - \frac{2}{{λ}_{a} δ t} ( {p}_{k}^{( a )} ( δ t ) - {N}_{k}^{( a )} ( δ t ) )$$

Note that in the above equations for the neuro-thermodynamic system using the A3 chip, both the gradient as well as the momentum of the synapses are written in terms of the measured momentum of the ancillas of the A3 chip at time δt. By performing subsequent measurements of the ancillas of the A3 chip, previously computed gradients and synapse momentums can be used to compute updated gradients and momentums of the ancillas of the A3 chip using the newly measured ancilla momentums. More particularly for an evolution of s time steps, each of size δt, the gradient at time sδt can be given by:

$$\begin{matrix}\frac{δ t}{2} \frac{\partial {H}_{tot}}{\partial {q}_{k}^{( s )}} {\vert}_{s δ t} = \frac{2}{{λ}_{a} δ t} [ {p}_{k}^{( a )} ( s δ t ) \\ + 4 {\sum }_{j = 1}^{s - 1} {( - 1 )}^{j} j {a}^{j} {p}_{k}^{( a )} ( ( s - j ) δ t ) \\ + {\sum }_{j = 1}^{s} {( - 1 )}^{j} j {a}^{j - 1} ( 2 j - 1 ) {N}_{k}^{( a )} ( ( s - j + 1 ) δ t ) ] \\ + {\sum }_{j = 1}^{s} {( - 1 )}^{j + 1} {a}^{j - 1} {N}_{k}^{( s )} ( ( s - j + 1 ) δ t )\end{matrix}$$

Said another way:

$$\begin{matrix}{Γ}_{k} [ s δ t ] ≡ \frac{2}{{λ}_{a} δ t} [ {p}_{k}^{( a )} ( s δ t ) \\ + 4 {\sum }_{j = 1}^{s - 1} {( - 1 )}^{j} j {a}^{j} {p}_{k}^{( a )} ( ( s - j ) δ t ) \\ + {\sum }_{j = 1}^{s} {( - 1 )}^{j} j {a}^{j - 1} ( 2 j - 1 ) {N}_{k}^{( a )} ( ( s - j + 1 ) δ t ) ] \\ + {\sum }_{j = 1}^{s} {( - 1 )}^{j + 1} {a}^{j - 1} {N}_{k}^{( s )} ( ( s - j + 1 ) δ t )\end{matrix}$$

These gradients can also be used to determine a time averaged gradient, using:

$${E}_{T} ( ∇ {H}_{total} ) ≡ \frac{2}{δ t} \frac{1}{T} {\sum }_{s = 1}^{T} ( {Γ}_{1} ( s δ t ) , … , {Γ}_{v} ( s δ t ) )$$

Also, the time averaged gradients can be used to compute components of the information matrix as shown in FIG. 7B (for the neuro-thermodynamic processor system implemented using the A3 chip). For example,

$${I}_{i , j}^{BKM} = {E}_{j , k}^{( 1 )} ( T ) - {E}_{j , k}^{( 2 )} ( T )$$

$$where :$$

$${E}_{j , k}^{( 1 )} ≡ \frac{4}{δ {t}^{2}} \frac{1}{T} {\sum }_{s = 1}^{T} {Γ}_{j} [ s δ t ] {Γ}_{k} [ s δ t ]$$

$$and$$

$${E}_{j , k}^{( 2 )} ≡ \frac{4}{δ {t}^{2}} ( \frac{1}{T} {\sum }_{s = 1}^{T} {Γ}_{j} [ s δ t ] ) ( \frac{1}{T} {\sum }_{s = 1}^{T} {Γ}_{k} [ s δ t ] )$$

Note that as explained in FIGS. 7A-7B and FIGS. 8A-8B, for both embodiments using the A3 chip and embodiments using the A1 and A2 chips, results of these equations (e.g. gradients and information matrix elements) can be calculated using ancilla oscillator momentum measurements and simple calculations, such as addition, subtraction, multiplication, division, and integration performed on a classical computing device.

Protocols for both the technique using the A3 ancilla thermodynamic chip and a technique using the A2 and A1 thermodynamic chips are shown in FIGS. 19A-19C and FIGS. 20A-20C, respectively. Corresponding equations for the two techniques (e.g. the protocol shown in FIGS. 19A-19C and the protocol shown in FIGS. 20A-20C) are shown in FIGS. 7A-7B and FIGS. 8A-8B. Note that results of the equations shown in FIGS. 7A-7B and results of the equations shown in FIGS. 8A-8B can be calculated on a classical computing device using simple operations and taking as inputs momentum measurements from ancilla oscillators of the respective ancilla thermodynamic chips uses (e.g. A3 for the first technique and A1 and A2 for the second technique).

Broadly speaking, classes of algorithms that may benefit from implementation using a neuro thermodynamic processing system include those algorithms that involve probabilistic inference. Such probabilistic inferences (which otherwise would be performed using a CPU or GPU) may instead be delegated to a thermodynamic processing chip for a faster and more energy efficient implementation. At a physical level, the thermodynamic chip harnesses electron fluctuations in superconductors coupled in flux loops to model Langevin dynamics. In some embodiments, architectures such as those described herein may resemble a partial self-learning architecture, wherein classical computing device(s) (e.g., a FPGA, ASIC, etc.) may be relied upon only to perform simple tasks such as multiplying, adding, subtracting, summing, and/or integrating measured values and performing other non-compute intensive operations in order to implement a learning algorithm (e.g., such as the natural gradient descent algorithm).

Note that in some embodiments, electro-magnetic or mechanical (or other suitable) oscillators may be used. A thermodynamic chip may implement neuro-thermodynamic computing and therefore may be said to be neuromorphic. For example, the neurons implemented using the oscillators of the thermodynamic chip may function as neurons of a neural network that has been implemented directly in hardware. Also, the thermodynamic chip is “thermodynamic” because the chip may be operated in the thermodynamic regime slightly above 0 Kelvin, wherein thermodynamic effects cannot be ignored. For example, some thermodynamic chips may be operated within the milli-Kelvin range, and/or at 2, 3, 4, etc. degrees Kelvin. The term thermodynamic chip also indicates that the thermal equilibrium dynamics of the neurons and ancillas are used to perform computations. In some embodiments, temperatures less than 15 Kelvin may be used. Though other temperatures ranges are also contemplated. This also, in some contexts, may be referred to as analog stochastic computing. In some embodiments, the temperature regime and/or oscillation frequencies used to implement the thermodynamic chips may be engineered to achieve certain statistical results. For example, the temperature, friction (e.g., damping) and/or oscillation frequency may be controlled variables that ensure the oscillators evolve according to a given dynamical model, such as Langevin dynamics. In some embodiments, temperature may be adjusted to control a level of noise introduced into the evolution of the neurons. As yet another example, a thermodynamic chip may be used to model energy models that require a Boltzmann distribution. Also, a neuro thermodynamic processing system may be used to solve variational algorithms and perform learning tasks and operations.

FIG. 1 is high-level diagram illustrating a process of determining weights and biases to be used in a Bayesian algorithm, wherein the weights and biases are determined using measurement values of ancilla oscillators of an ancilla thermodynamic chip that is coupled to a thermodynamic processor chip, and wherein visible neuron oscillators of the thermodynamic chip are used to implement, at least in part, the Bayesian algorithm, according to some embodiments.

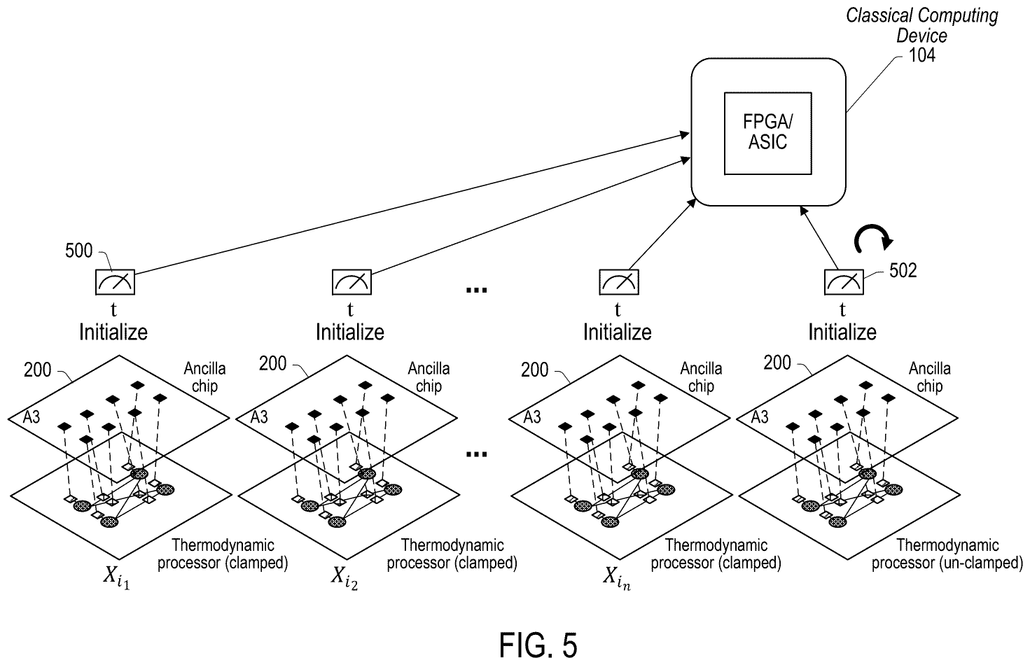

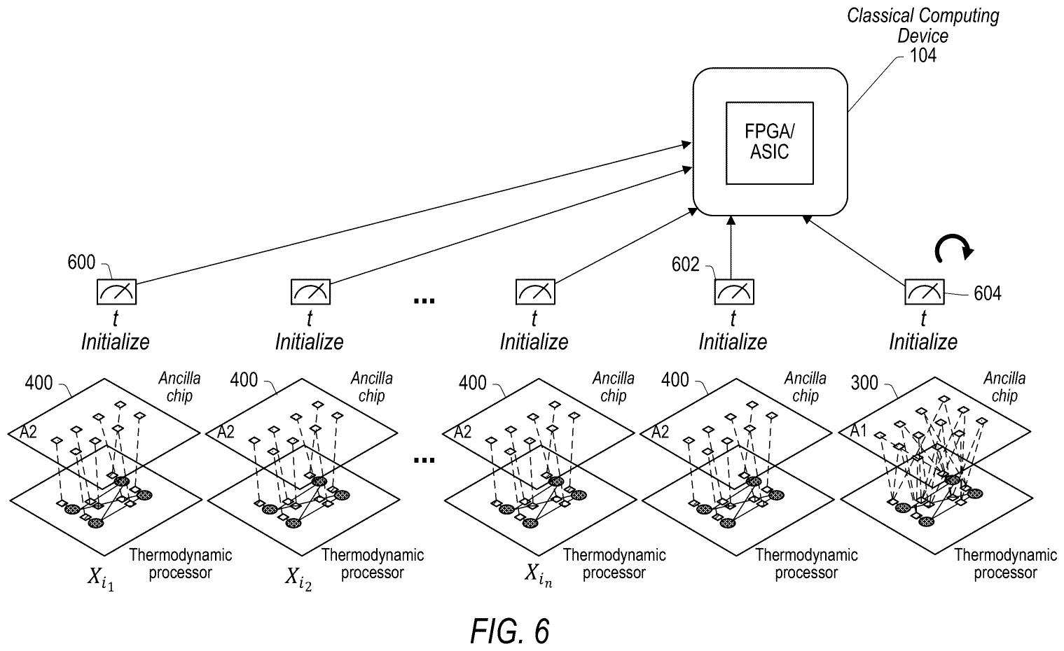

As shown in FIG. 1, in a first evolution, visible neurons of thermodynamic chip 102 may be clamped to input data. For example, as further shown in FIGS. 5 and 6, multiple mini-batches of input data may be clamped to visible neurons for multiple evolutions used to generate a first set of ancilla momentum measurements used to compute a positive phase term. For example, the ancilla momentum measurements from ancilla thermodynamic chip 106 may be used by classical computing device 104 to compute the positive phase term, using the equations shown in FIGS. 7A and 8A, depending on which type of ancilla thermodynamic chip is used. For example, if an A3 ancilla thermodynamic chip is used, the positive phase term may be computed using gradients determined from A3 ancilla oscillator measurements as shown in FIG. 7A. Also, if A1 and A2 ancilla thermodynamic chips are used, the positive phase term may be computed using gradients determined from A2 ancilla oscillator measurements as shown in FIG. 8A.

Also, in a second (or other subsequent) evolution, the visible neurons of the thermodynamic chip 102 may remain unclamped, such that the visible neuron oscillators are free to evolve along with the synapse oscillators during the second (or other subsequent) evolution. Momentum measurements of the ancilla oscillators of thermodynamic chip 106 may also be taken and used by the classical computing device 104 to compute a negative phase term. For example, if an A3 ancilla thermodynamic chip is used, the negative phase term may be computed using gradients determined from A3 ancilla oscillator measurements as shown in FIG. 7A. Also, if A1 and A2 ancilla thermodynamic chips are used, the negative phase term may be computed using gradients determined from A2 ancilla oscillator measurements as shown in FIG. 8A.

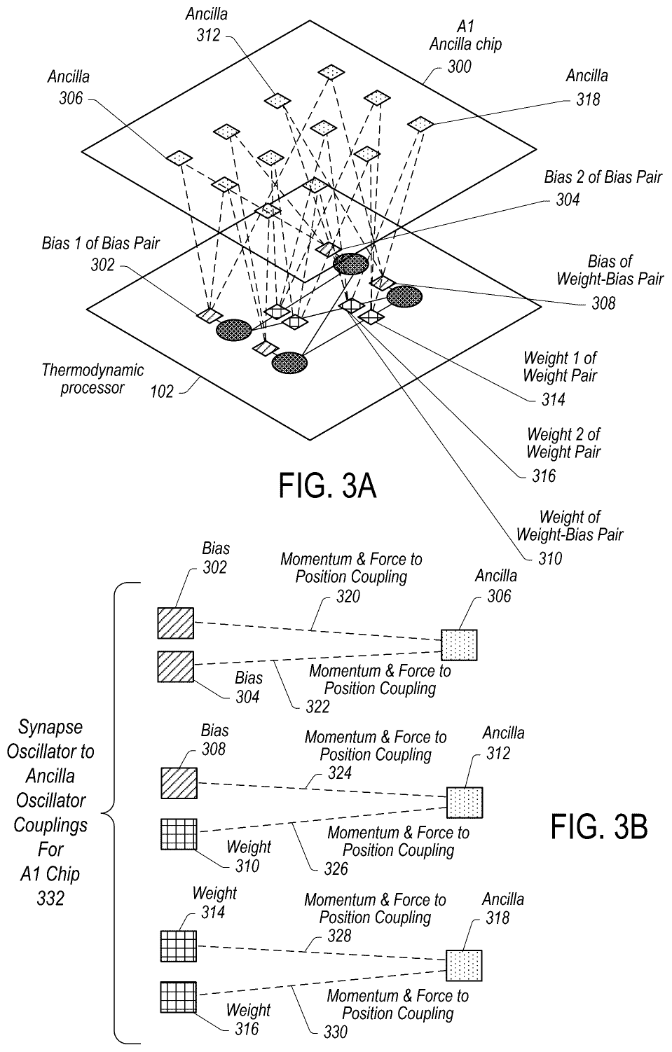

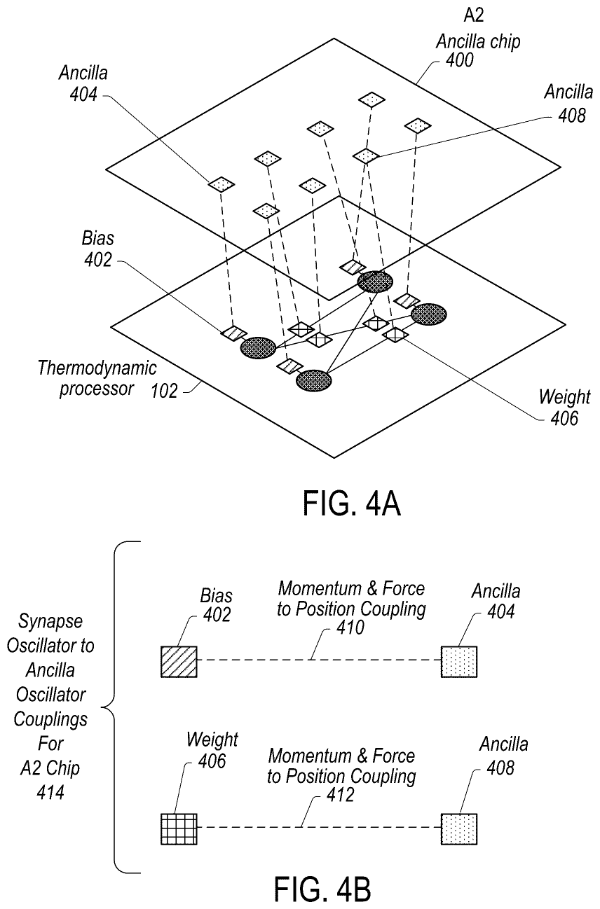

Also, in addition to computing the positive and negative phase terms, ancilla oscillator momentum measurements of the thermodynamic chip 106 taken during one or more of the unclamped evolutions may be used to determine elements of an information matrix, for example using the equations discussed above and further shown in FIGS. 7B and 8B. For example, when using the A3 ancilla thermodynamic chip (e.g., thermodynamic chip 106 is an A3 chip), elements of the information matrix may be determined using the equations shown in FIG. 7B, that take unclamped evolution A3 ancilla oscillator momentum measurements as inputs to the equations. As another example, when using the A1 and A2 ancilla thermodynamic chips (e.g. thermodynamic chip 106 used in the first and second evolutions (e.g. clamped and un-clamped) is an A2 chip and the thermodynamic chip 106 used in the third evolution (un-clamped) is an A1 chip, elements of the information matrix may be determined using the equations shown in FIG. 8B. For example, these equations take unclamped evolution A1 ancilla oscillator momentum measurements and unclamped evolution A2 ancilla oscillator momentum measurements, as inputs to the equations. Thus, in embodiments that use the A1 and A2 ancilla thermodynamic chips, an additional unclamped evolution may be performed with ancilla oscillators of the A1 ancilla thermodynamic chip coupled to sets of synapse oscillators of the thermodynamic processor chip using three-body couplings, such as shown in FIG. 3B. Also, ancilla oscillators of the A2 chip may be coupled to synapse oscillators of the thermodynamic processor chip using two-body couplings as shown in FIG. 4B

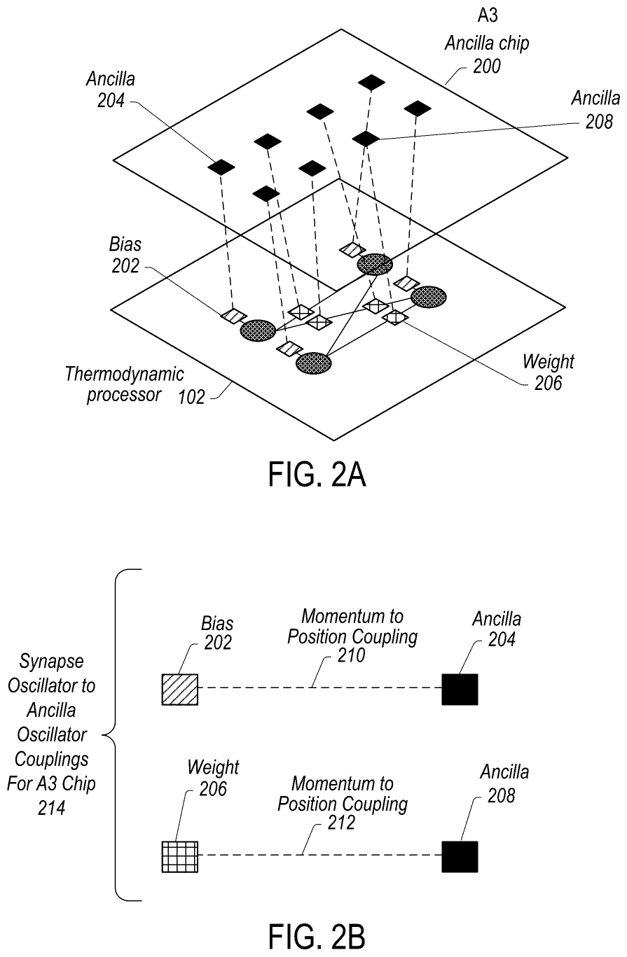

For embodiments that use the A3 chip, ancilla oscillators of the A3 chip may be coupled to synapse oscillators of the thermodynamic processor chip using two-body coupling as shown in FIG. 2B.

Additionally, the positive and negative phase terms computed based on the first and second sets of measurements (e.g., clamped measurements and un-clamped measurements) along with the determined information matrix (which may be determined using the measurements from the first and second evolution or optionally also using measurements from a third evolution) may be used to calculate updated weights and biases.

This process may be repeated, with the determined updated weights and biases used as initial weights and biases for a subsequent iteration. In some embodiments, inferences generated using the updated weights and biases may be compared to training data to determine if the energy-based model has been sufficiently trained. If so, the energy-based model may transition into a mode of performing inferences using the learned weights and biases. If not sufficiently trained, the process may continue with additional iterations of determining updated weights and biases.

FIG. 2A illustrates an example ancilla thermodynamic chip (A3 chip) coupled to a thermodynamic processor chip using momentum-to-position couplings between synapse oscillators of the thermodynamic processor chip and ancilla oscillators of the A3 ancilla thermodynamic chip, according to some embodiments.

A3 ancilla thermodynamic chip 200 includes ancilla oscillators, such as ancilla oscillators 204 and 208. Respective ones of the ancilla oscillators are coupled to respective ones of bias or weight (e.g. synapse) oscillators of thermodynamic processor chip 102, such as bias oscillator 202 or weight oscillator 206.

FIG. 2B provides additional detail regarding the two-body momentum-to-position couplings between the A3 ancilla thermodynamic chip and the thermodynamic processor chip, according to some embodiments.

For example, as shown in FIG. 2B, an A3 type ancilla thermodynamic chip 200 may be coupled to a thermodynamic processor chip 102 using synapse oscillator to ancilla oscillator couplings 214, for example where bias oscillator 202 is coupled to ancilla oscillator 204 using a two-body momentum-to-position coupling 210. In such a configuration, a momentum degree of freedom of the bias oscillator 202 may be coupled to a position degree of freedom of the ancilla oscillator 204. Note that while the coupling is momentum-to-position, the equations shown in FIGS. 7A and 7B use momentum measurements of the A3 ancilla chip 200 oscillators (e.g. ancilla oscillators 204, 208, etc.) that are affected by the momentum-to-position couplings 214 to the synapse oscillators of the thermodynamic processor chip. As another example, a momentum degree of freedom of weight oscillator 206 is coupled to a position degree of freedom of ancilla oscillator 208 using momentum-to-position coupling 212, wherein momentum measurements of ancilla oscillator 208 are used to determine gradients and information matrix elements for a neuro-thermodynamic processor system comprising an A3 ancilla thermodynamic chip coupled to a thermodynamic processor chip, such as A3 ancilla chip 200 coupled to thermodynamic processor chip 102 using couplings 214.

FIG. 3A illustrates an example ancilla thermodynamic chip (A1 chip) coupled to a thermodynamic processor chip using momentum-and-force-to-position couplings between sets of synapse oscillators of the thermodynamic processor chip and respective ancilla oscillators of the A1 ancilla thermodynamic chip, according to some embodiments.

A1 ancilla thermodynamic chip 300 includes ancilla oscillators, such as ancilla oscillators 306, 312, and 318. Respective ones of the ancilla oscillators are coupled to respective sets of bias or weight (e.g. synapse) oscillators of thermodynamic processor chip 102. For example, ancilla oscillator 306 is coupled to bias oscillator 302 and also coupled to bias oscillator 304. As another example, ancilla oscillator 312 is coupled to bias oscillator 308 and also coupled to weight oscillator 310. As yet another example, ancilla oscillator 318 is coupled to weight oscillator 314 and also coupled to weight oscillator 316. As can be seen in an A1 chip arrangement a given set of synapse oscillators to which an ancilla oscillator is coupled can include pairs of weight oscillators, pairs of bias oscillators, or mixed pairs including both a weight oscillator and a bias oscillator.

FIG. 3B provides additional detail regarding the three-body momentum-and-force-to-position couplings between the sets of synapse oscillators of the thermodynamic processor chip and the respective ancilla oscillators of the A1 ancilla thermodynamic chip, according to some embodiments.

For example, as shown in FIG. 3B, an A1 type ancilla thermodynamic chip may be coupled to a thermodynamic processor chip using synapse to oscillator couplings 332. For example, ancilla oscillator 306 is coupled to a set of synapse oscillators in a three-body coupling, wherein the set of synapse oscillators include bias oscillator 302 and bias oscillator 304. Also, momentum-and-force-to-position couplings 320 and 322 between the synapse oscillators and the ancilla oscillator may are used to implement the three-body coupling. In such a configuration, a momentum degree of freedom and a force degree of freedom of the bias oscillator 302 may be coupled to a position degree of freedom of the ancilla oscillator 306. Also, a momentum degree of freedom and a force degree of freedom of the bias oscillator 304 are coupled to the position degree of freedom of the ancilla oscillator 306 Note that while the coupling is momentum-and-force-to-position, the equations shown in FIGS. 8A and 8B use momentum measurements of the A2 and A1 ancilla oscillators, that are affected by the momentum-and-force-to-position couplings to the synapse oscillators of the thermodynamic processor chip. Thus, it is the momentum degree of freedom of the ancilla oscillators (such as ancilla oscillators 306, 312, 318, etc.) that are measured, but these measurements are affected by force and momentums of the synapse oscillators via the couplings 332.

Also, as seen in FIG. 3B, ancilla oscillator 312 is coupled to bias oscillator 308 via momentum-and-force-to-position coupling 324 and ancilla oscillator 312 is also coupled to weight oscillator 310 via momentum-and-force-to-position coupling 326. Additionally, ancilla oscillator 318 is coupled to weight oscillator 314 via momentum-and-force-to-position coupling 328 and ancilla oscillator 318 is coupled to weight oscillator 316 via momentum-and-force-to-position coupling 330.

FIG. 4A illustrates an example ancilla thermodynamic chip (A2 chip) coupled to a thermodynamic processor chip using momentum-and-force-to-position couplings between synapse oscillators of the thermodynamic processor chip and ancilla oscillators of the A2 ancilla thermodynamic chip, according to some embodiments.

A2 ancilla thermodynamic chip 400 includes ancilla oscillators, such as ancilla oscillators 404 and 408. Respective ones of the ancilla oscillators are coupled to respective ones of bias or weight (e.g. synapse) oscillators of thermodynamic processor chip 102, such as bias oscillator 402 or weight oscillator 406.

FIG. 4B provides additional detail regarding the two-body momentum-and-force-to-position couplings between the synapse oscillators of the thermodynamic processor chip and the ancilla oscillators of the A2 ancilla thermodynamic chip, according to some embodiments.

For example, as shown in FIG. 4B, an A2 type ancilla thermodynamic chip 400 may be coupled to a thermodynamic processor chip 102 using synapse to oscillator couplings 414, for example where bias oscillator 402 is coupled to ancilla oscillator 404 using a two-body momentum-and-force-to-position coupling 410. In such a configuration, a momentum degree of freedom of the bias oscillator 402 and a force degree of freedom of the bias oscillator 402 may be coupled to a position degree of freedom of the ancilla oscillator 404. Note that while the coupling is momentum-and-force to-position, the equations shown in FIGS. 8A and 8B use momentum measurements of the A2 ancilla chip 400 oscillators (e.g. ancilla oscillators 404, 408, etc.), that are affected by the momentum-and-force-to-position couplings 414 to the synapse oscillators of the thermodynamic processor chip. As another example, a momentum degree of freedom and a force degree of freedom of weight oscillator 406 is coupled to a position degree of freedom of ancilla oscillator 408 using momentum-and-force-to-position coupling 412, wherein momentum measurements of ancilla oscillator 408 are used to determine gradients and information matrix elements for a neuro-thermodynamic processor system comprising an A2 ancilla thermodynamic chip coupled to a thermodynamic processor chip, such as A2 ancilla chip 400 coupled to thermodynamic processor chip 102 using couplings 414.

FIG. 5 is a high-level diagram illustrating ancilla oscillator measurements being taken for evolutions of a neuro-thermodynamic processor system comprising a thermodynamic processor chip and an ancilla thermodynamic chip (A3 chip), wherein the visible neuron oscillators of the thermodynamic processor chip are clamped to mini-batches of input training data during evolutions for which a first set of measurements are taken from ancilla oscillator of the ancilla thermodynamic chip (A3 chip), and wherein the visible neuron oscillators of the thermodynamic process chip are left un-clamped during an additional one or more evolutions for which a second set of measurements are taken from the ancilla oscillators of the ancilla thermodynamic chip (A3 chip), according to some embodiments.

The process shown in FIG. 5 corresponds with the algorithms shown in FIGS. 19A-19C. At each of the shown evolutions 500, the thermodynamic chip is initialized with a set of synapse values corresponding to a current set of weights and biases (for which updates are being determined). For each mini-batch of a set of input training data, the visible neurons are clamped to corresponding elements of the mini-batch of training data. While the visible neuron oscillators are clamped, the synapse oscillators and ancilla oscillators are allowed to evolve according to Langevin dynamics, e.g., they evolve for a time t (as shown in FIG. 5). During the evolution, the momentum of the ancilla oscillators is measured, such as shown in FIG. 11. Also, during the un-clamped phase 502, the weights and biases are also initialized to the current weight and bias values for which an update is being determined. However, in the un-clamped phase 502, both the visible neuron oscillators and the synapse oscillators (along with the ancilla oscillators) are allowed to evolve according to Langevin dynamics. For the un-clamped phase 502, during the evolution, the momentum of the ancilla oscillators is measured as shown in FIG. 11. After the evolution, a gradient for the un-clamped phase is computed on the classical computing device 104, for example, based on the received ancilla oscillator momentum measurements. The gradient for the clamped phase (e.g., log prior term) may also be computed on the classical computing device 104. Additionally, the elements of the information matrix (e.g. expectation values) are computed on the classical computing device 104. New weights and biases are then computed on the classical computing device using the determined gradients and information matrix. These newly computed updated weights and biases may then be used to initialize another iteration of learning.

In some embodiments, fast measurements at a time scale faster than a time scale in which the synapse oscillators reach thermal equilibrium may be taken for the clamped phase 500 and the un-clamped phase 502. For example, measurements may be taken at a faster pace (e.g., at each ST interval), wherein ST is smaller than the time required for the synapse oscillators to reach thermal equilibrium. In some embodiments, the gradients may be determined using a value from a previous time step, wherein an update for a subsequent time step is used to update the computed gradient of the prior time step.

FIG. 6 is a high-level diagram illustrating ancilla oscillator measurements being taken for evolutions of a neuro-thermodynamic processor system comprising a thermodynamic processor chip and A1 and A2 ancilla thermodynamic chips, wherein the visible neuron oscillators of the thermodynamic processor chip are clamped to mini-batches of input training data during evolutions for which a first set of measurements are taken using ancilla oscillators of the A2 ancilla thermodynamic chip, wherein the visible neuron oscillators of the thermodynamic processor chip are left un-clamped during another evolution for which other measurements are taken using the ancilla oscillators of the A2 ancilla thermodynamic chip, wherein yet another un-clamped evolution is performed for which additional measurements are taken using the ancilla oscillators of the A1 ancilla thermodynamic chip, according to some embodiments.

In embodiments that use the A1 and A2 thermodynamic chip, momentum measurements for the clamped phase 600 may be taken using the A2 ancilla thermodynamic chip, such as ancilla thermodynamic chip 400 coupled to thermodynamic processor 102 using couplings 414. In a similar manner to the embodiment for the A3 chip described in FIG. 5, multiple mini-batches of training data may be coupled to the thermodynamic processor chip 102 and momentum measurements for multiple evolutions for the respective mini-batches may be taken from the ancilla oscillators of the A2 chip 400.

Also, an un-clamped evolution may be performed using the A2 ancilla thermodynamic chip 400 at un-clamped phase 602 and corresponding momentum measurements may be made using the A2 ancilla thermodynamic chip 400. Likewise, an additional un-clamped evolution may be performed using the A1 ancilla thermodynamic chip 300 at un-clamped phase 604, wherein the A1 ancilla thermodynamic chip 300 is coupled to thermodynamic processor chip 102 using couplings 332. For the un-clamped phase 604, momentum measurements of the ancilla oscillators of the A1 ancilla thermodynamic chip 300 are taken and used to compute the elements of the information matrix as further shown in FIG. 8B.

FIG. 7A illustrates an example equations for determining gradients that are used in determining updated weights and biases, wherein the gradients are determined using ancilla oscillator measurements results from an A3 ancilla thermodynamic chip and simple addition, subtraction, multiplication, and summation operations performed by a classical computing device, according to some embodiments.

For example, determining the gradients for the clamped phase uses momentum measurements 702 from the A3 ancilla thermodynamic chip 200 as inputs to the equation shown in FIG. 7A. Additionally, these gradients can be used to determine a time-averaged gradient, as also shown in FIG. 7A. A similar process is performed for the un-clamped phase (e.g. to determine gradients for a negative phase term). For example, momentum measurements 704 from the A3 ancilla thermodynamic chip 200 are used as inputs to determining the negative phase gradient, using the equation shown in FIG. 7A (for the un-clamped phase). These gradients may also be used to determine a time-averaged gradient, also as shown in FIG. 7A.

FIG. 7B illustrates an example information matrix that is used in determining updated weight and biases values, for example when using a natural gradient descent technique, wherein the components of the information matrix are determined using ancilla oscillator measurement results from an A3 ancilla thermodynamic chip and simple multiplication and summation operations performed by a classical computing device, according to some embodiments.

For example, as discussed above, the information matrix (e.g. information matrix 754) may correspond to elements of a vector of current weights and biases (e.g. current weights and biases vector 752). Also, as shown in the above equations, the new weights may be calculated using an equation involving the Moore-Penrose pseudo inverse of the information matrix (e.g. I⁺). As shown in FIG. 7B, each of the information matrix entries may be calculated using the equations shown in FIG. 7B, wherein the first term is computed using the equation below that can be calculated from measured momentum results and the second term is also computed using the equation below that can be calculated from measured momentum results. For example, products of gradients 756 can be determined using measured momentum results from the A3 ancilla thermodynamic chip. Also, product of synapse pair gradients 758 can be determined using measured momentum results from the A3 thermodynamic chip.

FIG. 8A illustrates an example equations for determining gradients that are used in determining updated weights and biases, wherein the gradients are determined using ancilla oscillator measurements of an A2 ancilla thermodynamic chip and simple addition, subtraction, multiplication, and integration operations performed by a classical computing device, according to some embodiments.

For example, determining gradients for the clamped phase uses momentum measurements 802 from the A2 ancilla thermodynamic chip 400 as inputs to the equation shown in FIG. 8A. A similar process is performed for the un-clamped phase (e.g. to determine gradients for a negative phase term). For example, momentum measurements 804 from the A2 ancilla thermodynamic chip 400 are used as inputs to determining the negative phase gradient, using the equation shown in FIG. 8A (for the un-clamped phase). Note that there are two coupling arrangements for this second technique, a coupling arrangement using the A2 chip, which results in the Hamiltonian shown in FIG. 8A. Also, a second Hamiltonian for a coupling arrangement for the A1 chip applies, and is shown in FIG. 8B.

FIG. 8B illustrates an example information matrix that is used in determining updated weight and biases values, for example when using a natural gradient descent technique, wherein the components of the information matrix are determined using ancilla oscillator measurement results from A1 and A2 ancilla thermodynamic chips and simple addition, subtraction, multiplication and integration operations performed by a classical computing device, according to some embodiments.

For example, as discussed above, the information matrix (e.g. information matrix 854) may correspond to elements of a vector of current weights and biases (e.g. current weights and biases vector 852). Also, as shown in the above equations, the new weights may be calculated using an equation involving the Moore-Penrose pseudo inverse of the information matrix (e.g. I⁺). As shown in FIG. 8B, each of the information matrix entries may be calculated using the equations shown in FIG. 8B. Wherein the first term in the equation is computed using the equation below that can be calculated from measured momentum results and the second term in the equation is also computed using the equation below that can be calculated from measured momentum results. For example, the first term can be calculated using differences in measured momentums 856 (measured from the A1 ancilla chip) and the integral of momentums 858 (measured from the A1 ancilla chip). Also, the second term can be calculated using differences in momentums 860 (measured from the A2 ancilla chip) and integral of momentums 862 (measured from the A2 chip). Note that the Hamiltonian used in calculating the first term is the Hamiltonian describing the coupling with the A1 ancilla chip, which is given in FIG. 8B, and which is different than the Hamiltonian describing coupling with the A2 chip (which is given in FIG. 8A).

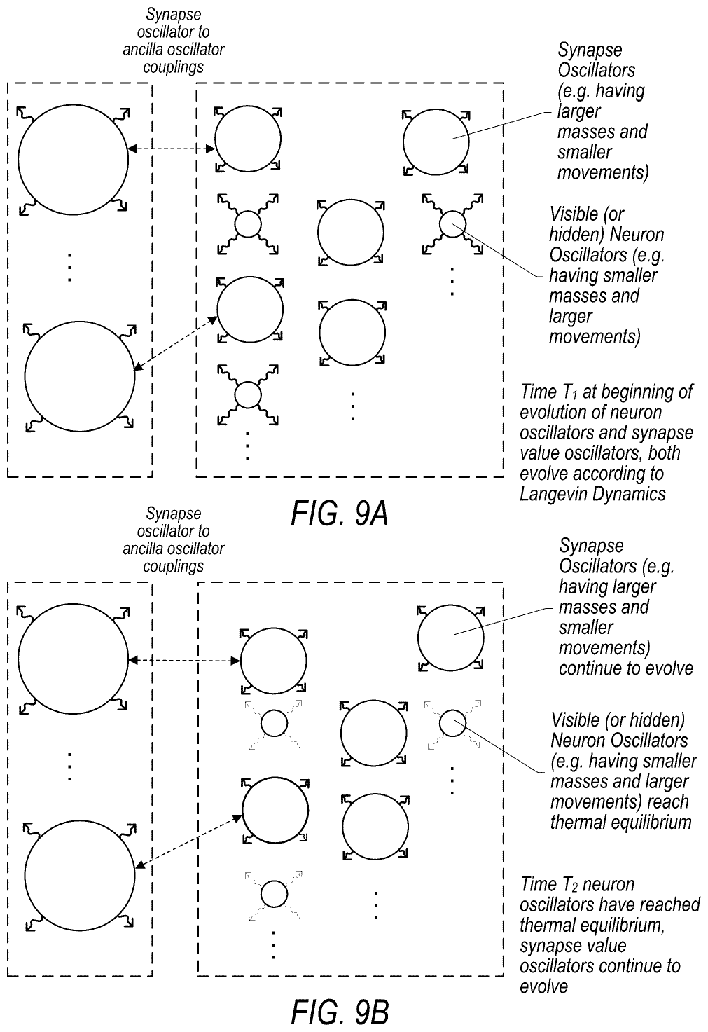

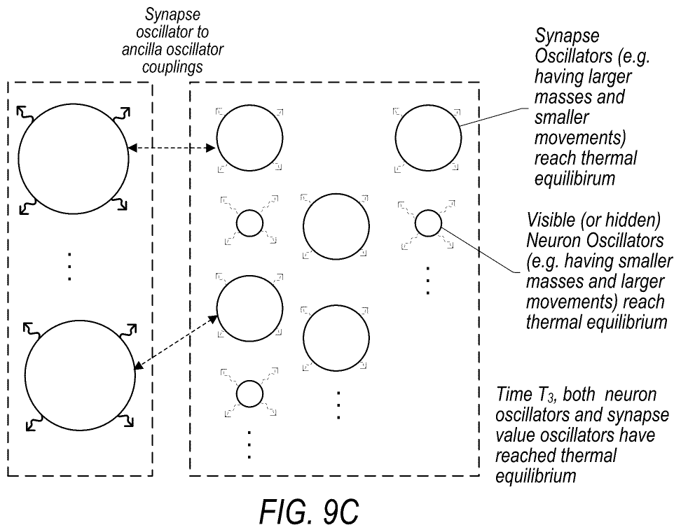

FIG. 9A is an illustrative diagram showing relative masses and motions of ancilla oscillators, synapse oscillators, and neuron oscillators of an ancilla thermodynamic chip and a thermodynamic processor chip at a time T₁ corresponding to an initial portion of an evolution of a neuro-thermodynamic processor system comprising the ancilla thermodynamic chip and the thermodynamic processor chip, according to some embodiments.

At a time T₁, for example at a beginning of an evolution of the un-clamped phase, both visible neuron oscillators (and if present, hidden neuron oscillators) along with synapse oscillators and ancilla oscillators evolve according to Langevin dynamics. In FIG. 9A the sizes of the circles are intended to indicate relative masses of the oscillators, wherein the synapse oscillators have larger masses than the visible neuron oscillators, and wherein the ancilla oscillators have larger masses than the synapse oscillators. Accordingly, the synapse oscillators have smaller displacements (as represented by the smaller squiggly arrows) than the visible neuron oscillators. Also, due to the larger masses, the synapse oscillators take a longer time to reach thermal equilibrium than the visible neuron oscillators. Likewise, the ancilla oscillators have larger masses than the synapse oscillators. As such the position degrees of freedom of the ancilla oscillators can be treated as constant during the evolution.

FIG. 9B is an illustrative diagram showing the relative masses and motions of the ancilla oscillators, synapse oscillators, and the neuron oscillators of the ancilla thermodynamic chip and the thermodynamic processor chip at a time T₂ corresponding to a point in time in the evolution wherein the neuron oscillators have reached a thermal equilibrium, but the synapse oscillators and ancilla oscillators have not yet reached thermal equilibrium and continue to evolve, according to some embodiments.

At time T₂ the smaller (in mass terms) visible neuron oscillators have reached thermal equilibrium, but the larger (in mass terms) synapse oscillators and ancilla oscillators continue to evolve and have not yet reached thermal equilibrium. Note that even after the visible neuron oscillators reach thermal equilibrium, they may continue to move (e.g. change position). However, at thermal equilibrium, their motion is described by the Boltzmann distribution.

FIG. 9C is an illustrative diagram showing the relative masses and motions of the ancilla oscillators, synapse oscillators, and the neuron oscillators of the ancilla thermodynamic chip and the thermodynamic processor chip at a time T₃ corresponding to a point in time in the evolution wherein the neuron oscillators and the synapse oscillators have reached thermal equilibrium, according to some embodiments.

At time T₃ both the visible neuron oscillators and the synapse oscillators have reached thermal equilibrium, but the ancilla oscillators continue to evolve. As discussed above, at thermal equilibrium, the visible neuron oscillators and the synapse oscillators will continue to move with their motion described by the Boltzmann distribution. Thus, the thin dotted lines in FIGS. 9A-9C indicate motion at thermal equilibrium, whereas the darker solid lines indicate motion that varies with time as the visible neuron oscillators and the synapse oscillators evolve, respectively, from initialization states to respective thermal equilibrium states.

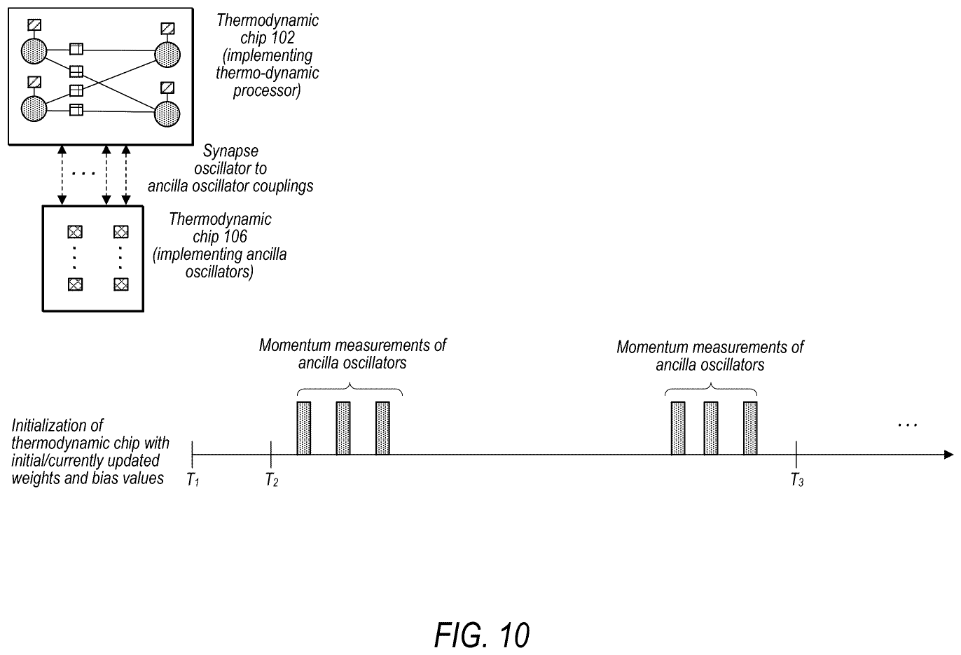

FIG. 10 illustrates an example of momentum measurements being taken of the ancilla oscillators between time T₂ and time T₃, wherein a set of momentum measurements of the ancilla oscillators are taken sequentially close in time to one another shortly after the neuron oscillators have reached thermal equilibrium and another set of momentum measurements of the ancilla oscillators are taken sequentially close in time to one another sometime later, which may be shortly before the synapse oscillators reach thermal equilibrium, according to some embodiments.

In some embodiments, momentum measurements of ancilla oscillators may be used in a learning algorithm, such as shown in FIGS. 20A-20C. In such embodiments, the thermodynamic processor chip (and the classical computing device) may be initialized with an initial set of weights and biases (or a most recently updated set of weights and biases resulting from a prior round of learning). For each evolution, e.g., both the clamped and the un-clamped evolutions, momentum measurements may be taken as shown in FIG. 10. For example, slightly after time 2 (when the visible neuron oscillators reach thermal equilibrium) a set of momentum measurements may be taken in rapid succession. This approach is applicable when the evolution of the momentum of the ancilla oscillators is approximately linear. In circumstances wherein momentum evolution of the ancilla oscillators cannot be approximated as linear, a different position measuring regime as further discussed in FIG. 11, may be used.

In a similar manner as described above with respect to the set of momentum measurements taken in rapid succession slightly after time 2, a rapid set of momentum measurements may be taken some time later, such as shortly before time 3, e.g., towards the end of the evolution and prior to the synapse oscillators reaching thermal equilibrium. Also, in some embodiments, the second set of momentum measurements may be taken in rapid succession at another time subsequent to when the first set of momentum measurements were taken. For example, sufficient spacing to allow for an accurate time average to be compute is sufficient, and it is not necessary to wait until the synapse oscillators reach thermal equilibrium. Though, such an approach is also a valid implementation. Thus, in some embodiments, T₃ may occur well before an amount of time sufficient for the synapse oscillators to reach thermal equilibrium has elapsed. Also, in some embodiments, wherein it is known that the oscillator degrees of freedom representing the ancilla oscillators are in the linear regime, the requirement that momentum measurements be taken in rapid succession can be relaxed. For example, if changes in momentum are linear (e.g. occurring under a near constant force) then arbitrary spacing of the momentum measurements will result in equivalent computed gradient values.

FIG. 11 illustrates an example of multiple momentum measurements being taken of the ancilla oscillators between time T₂ (when the neuron oscillators reach thermal equilibrium) and time T₃, according to some embodiments.

In some embodiments, instead of taking a set of momentum measurements slightly after time T₂ and again slightly before time T₃ and using these sets of momentum measurements to determine a time averaged gradient, a measurement scheme as shown in FIG. 11 may be employed wherein a larger quantity of momentum measurements are taken at each time interval St (as shown in FIG. 5). These ancilla oscillator momentum measurements may be used in an integration to determine a time averaged gradient, in some embodiments.

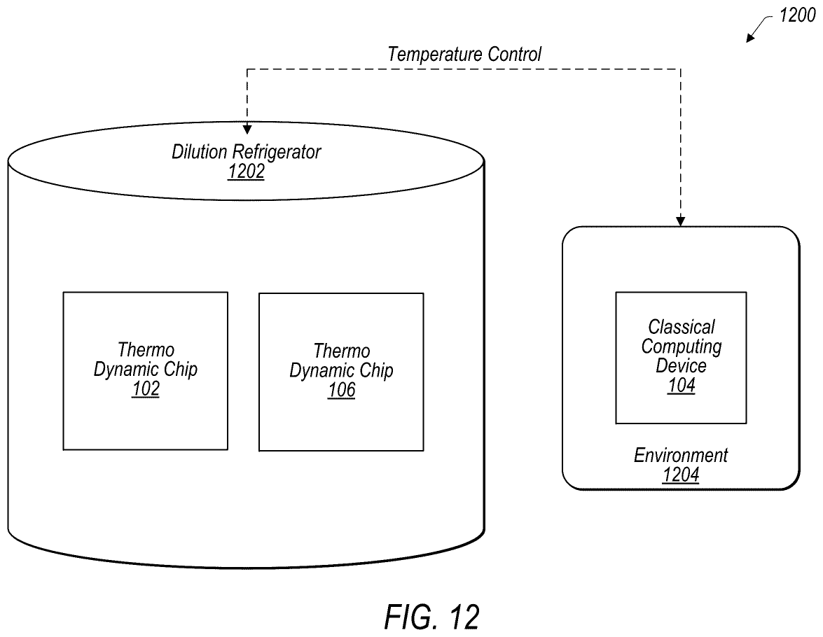

FIG. 12 is high-level diagram illustrating an example neuro-thermodynamic processor system comprising an ancilla thermodynamic chip and a thermodynamic processor chip included in a dilution refrigerator and coupled to a classical computing device in an environment external to the dilution refrigerator, according to some embodiments.

In some embodiments, a neuro-thermodynamic computing system 1200 (as shown in FIG. 12) may be used to implement the various embodiments shown in FIGS. 1-11 and may include a thermodynamic chip 102 and a thermodynamic chip 106 (e.g. ancilla chip, such as A1, A2, and/or A3 chips) placed in a dilution refrigerator 1202. In some embodiments, classical computing device 104 may control temperature for dilution refrigerator 1202, and/or perform other tasks, such as helping to drive a pulse drive to change respective hyperparameters of the given system and/or perform measurements, such as those shown in FIGS. 1-11. Also, the classical computing device 104 may perform other simple computing operations, such as are needed to determine updated weights and biases based a first set of measurements of ancilla oscillators subsequent to (or during) a clamped evolution and based on a second set of measurements of ancilla oscillators subsequent to (or during) an un-clamped evolution.

In some embodiments, classical computing device 104 may include one or more devices such as a field-programmable gate array (FPGA), an application specific integrated circuit (ASIC), and/or other devices that may be configured to interact and/or interface with a thermodynamic chip within the architecture of neuro-thermodynamic computer 1200. For example, such devices may be used to tune hyperparameters of the given thermodynamic system, etc. as well as perform part of the calculations necessary to determine updated weights and biases.

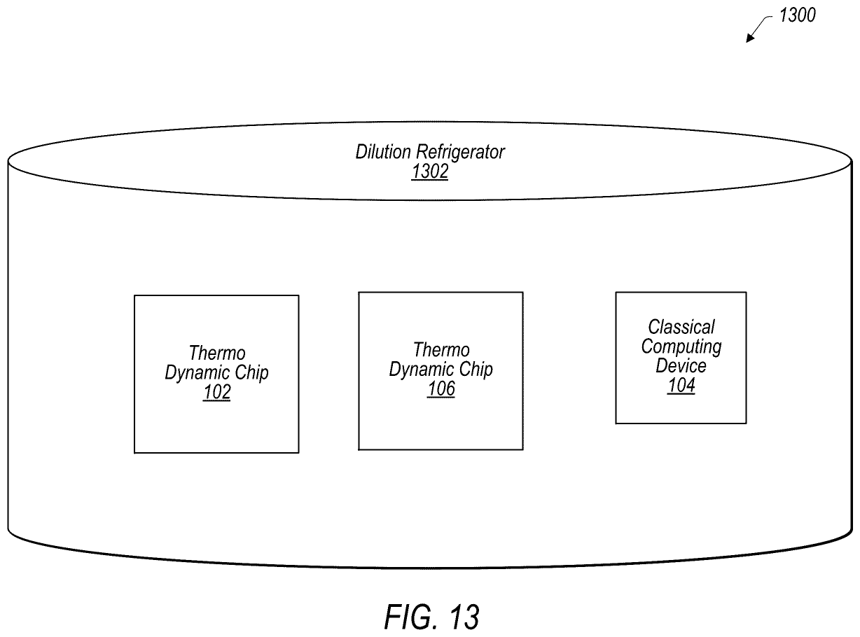

FIG. 13 is high-level diagram illustrating an example neuro-thermodynamic processor system comprising an ancilla thermodynamic chip and a thermodynamic processor chip included in a dilution refrigerator and coupled to a classical computing device that is also included in the dilution refrigerator, according to some embodiments.

As another alternative, in some embodiments, a classical computing device used in a neuro-thermodynamic computer, such as in neuro-thermodynamic computer 1300, may be included in a dilution refrigerator with the thermodynamic chips, such as thermodynamic chip 102 and thermodynamic chip 1-6. For example, neuro-thermodynamic computer 1300 includes both thermodynamic chips 102 and 106 and classical computing device 104 in dilution refrigerator 1302.

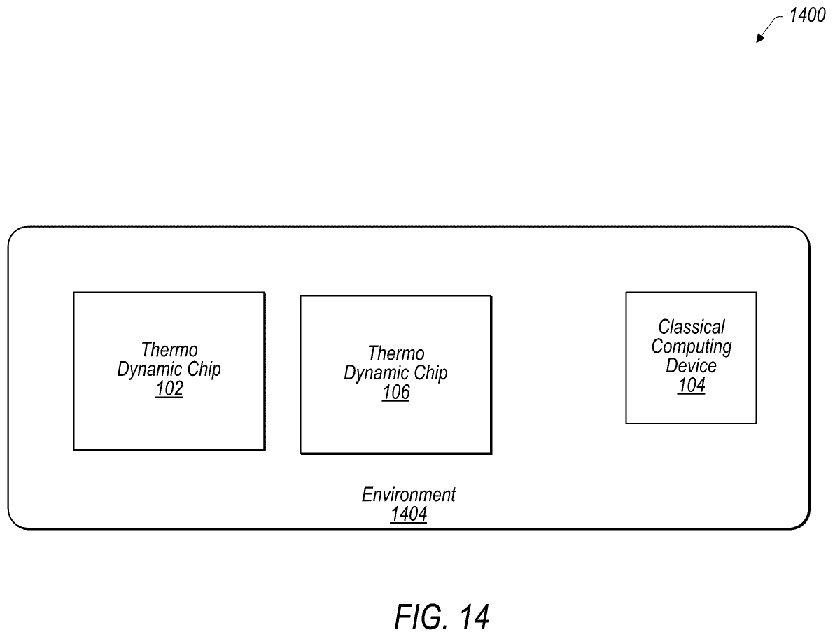

FIG. 14 is high-level diagram illustrating an example neuro-thermodynamic processor system comprising an ancilla thermodynamic chip and a thermodynamic processor chip coupled to a classical computing device in an environment other than a dilution refrigerator, according to some embodiments.

Also, in some embodiments, a neuro-thermodynamic computer, such as neuro-thermodynamic computer 1400, may be implemented in an environment other than a dilution refrigerator. For example, neuro-thermodynamic computer 1400 includes thermodynamic chips 102 and 1-6 and classical computing device 104, in environment 1404. In some embodiments, environment 1404 may be temperature controlled and, the classical computing device (or other device) may control the temperature of environment 1404 in order to achieve a given level of evolution according to Langevin dynamics.

FIG. 15 is a high-level diagram illustrating oscillators included in a substrate of a thermodynamic chip, such as a thermodynamic processor chip, and a mapping of the oscillators to logical neurons or synapses of the thermodynamic chip, according to some embodiments. Note that a similar substrate may be used for an ancilla thermodynamic chip, however the oscillators of the ancilla thermodynamic chip are coupled to synapse oscillators of a corresponding thermodynamic processor chip, according to some embodiments.

In some embodiments, a substrate 1502 may be included in a thermodynamic chip, such as any one of the thermodynamic chips described above, such as thermodynamic chip 102 or thermodynamic chip 106. Oscillators 1504 of substrate 1502 may be mapped in a logical representation 1552 to neurons 1554, as well as weights and biases (shown in FIG. 16). In some embodiments, oscillators 1504 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 1504. In some embodiments, the oscillators 1504 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 15 for oscillator 1504. However, in some embodiments, generally speaking various non-linear flux loops may be used to implement the oscillators 1504, such as those having single-well potential, double-well potential, or various other potentials, such as a potential somewhere between a single-well potential and a double-well potential.

FIG. 16 is an additional high-level diagram illustrating oscillators included in a substrate of the thermodynamic chip mapped to logical neurons, weights, and biases (e.g., synapses) of a neuro-thermodynamic processor system, according to some embodiments.

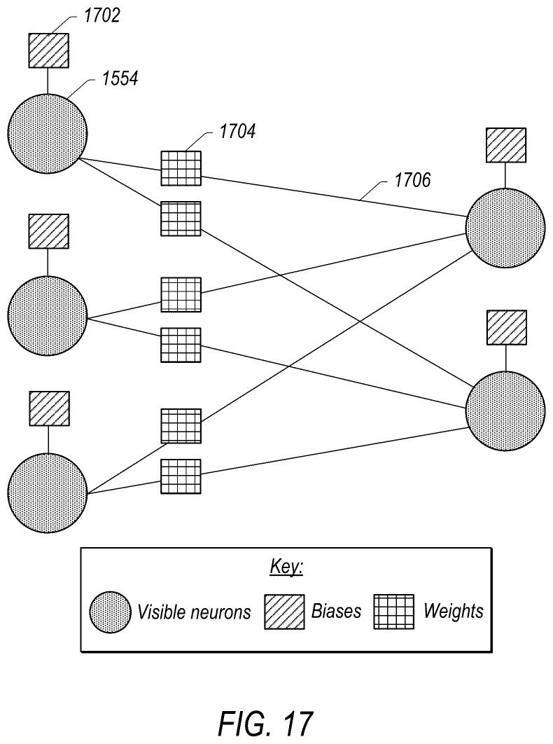

While weights and biases are not shown in FIG. 15 for ease of illustration, respective ones of the visible neurons 1554 of FIG. 15 may each have an associated bias, and edges connecting the neurons 1554 may have associated weights. For example, FIG. 17 illustrates an arrangement of five visible neurons along with associated weights and biases. Each of the weights and biases (such as those shown in FIG. 16) may be mapped to oscillators in the thermodynamic chip, as well as the visible (and non-visible) neurons being mapped to oscillators in the thermodynamic chip. For example, FIG. 16 shows a portion of a thermodynamic chip, wherein weights and biases associated with a given neuron 1654 are shown. For example, bias 1656 may be a bias value for visible neuron 1654 and weights 1658 and 1660 may be weights for edges formed between visible neuron 1654 and other visible neurons of the thermodynamic chip. As shown in FIG. 16, each of the chip elements (visible neuron 1654, bias 1656, weight 1658, and weight 1660) may be mapped to separate ones of oscillators 1604. This may allow the visible neurons (and/or hidden neurons), weights, and biases to have independent degrees of freedom within a given thermodynamic chip that can separately evolve.

In some embodiments, oscillators associated with weights and biases, such as bias 1656 and weights 1658 and 1660, may be allowed to evolve during a training phase and may be held nearly constant during an inference phase. For example, in some embodiments, larger “masses” may be used for the weights and biases such that the weights and biases evolve more slowly than the visible neurons. This may have the effect of holding the weight values and the bias values nearly constant during an evolution phase used for generating inference values.

FIG. 17 illustrates example couplings between visible neurons, weights, and biases (e.g., synapses) of a thermodynamic chip, according to some embodiments.

In some embodiments, visible neurons, such as visible neurons 1554, may be linked via connected edges 1706. Furthermore, as shown in FIG. 17, such visible neurons may additionally be linked to corresponding biases (e.g., synapses), such as biases 1702, and to weights (e.g., synapses), such as weights 1704. Recall that neurons, weights, and biases are logical representations of physical oscillators. Such that when describing neurons, weights, and biases in FIG. 17 it should be understood that these elements are implemented using oscillators and couplings as shown in FIG. 15. Also, as discussed in FIGS. 9A-9C, the synapse oscillators may have a larger mass than the neuron oscillators, such that the synapse oscillators evolve over a longer timescale than a timescale in which the neurons oscillators evolve.

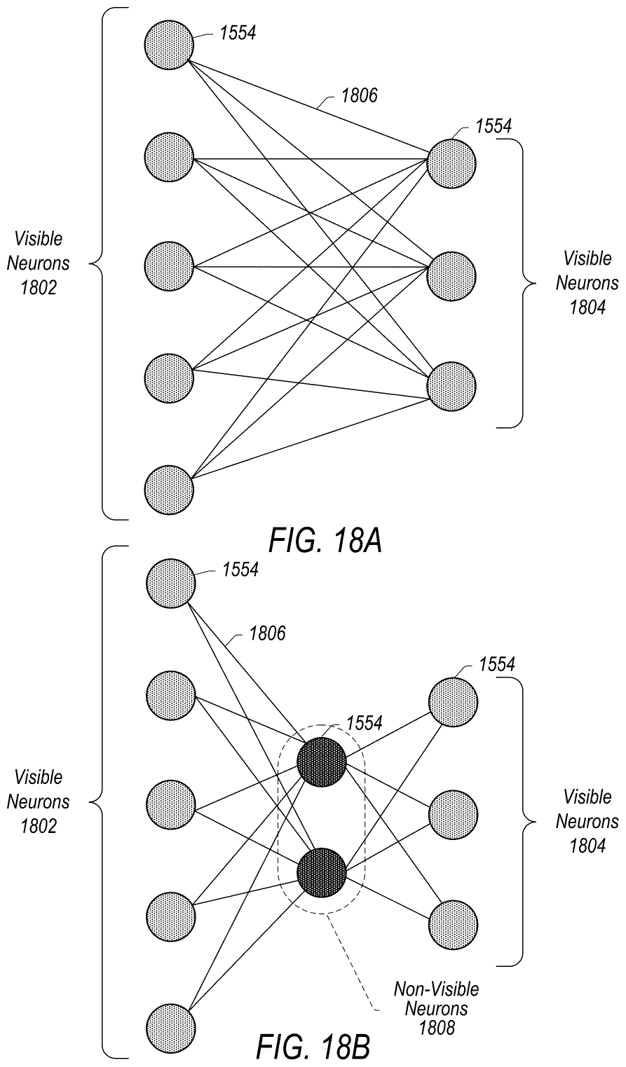

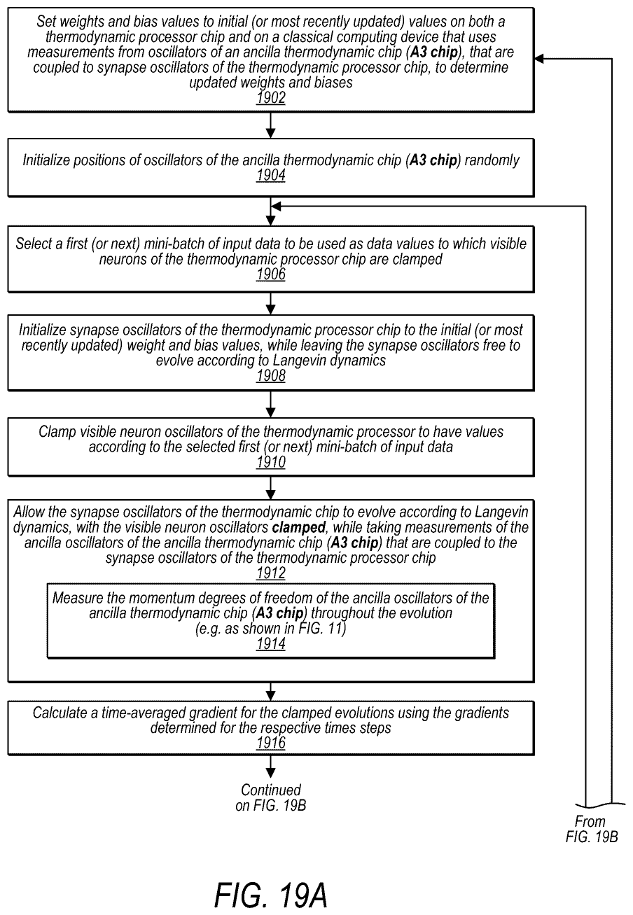

FIG. 18A illustrates example couplings between visible neurons of a thermodynamic chip, according to some embodiments.

In some embodiments, input neurons and output neurons, such as visible neurons 1802 and visible neurons 1804, may be directly linked via connected edges 1806. As shown in FIG. 18A, a given visible neuron 1802 of the five shown in the figure is connected, via edges 1806, to each of the respective three visible neurons 1804. A person having ordinary skill in the art should understand that FIG. 18A is meant to represent example embodiments of a graph architecture implemented using a thermodynamic chip that may be applied for image classification, for example, and that specific numbers of visible neurons 1802 and/or visible neurons 1804 shown in the figure are not meant to be restrictive. Additional configurations combining more/less visible neurons 1802 and/or visible neurons 1804 are also encompassed by the discussion herein. In addition, recall that neurons are logical representations of physical oscillators, such that, when describing neurons in FIGS. 18A and 18B, it should be understood that neurons and edges are implemented using oscillators and couplings as shown in FIG. 17.

FIG. 18B illustrates example couplings between visible neurons and non-visible neurons (e.g., hidden neurons) of a thermodynamic chip, according to some embodiments.

In some embodiments, FIG. 18B may resemble additional example embodiments of an architecture implemented using a thermodynamic chip. As shown in the figure, additional non-visible neurons 1808 may be used, which are respectively coupled, via edges 1806, to both visible neurons 1802 and to visible neurons 1804. Note that while the non-visible neurons are “not visible” from the perspective of inputs and outputs, the non-visible neurons may each correspond to a given oscillator, such as a given oscillator 1804 as shown in FIG. 15. In addition, it may be noted that, in some embodiments that make use of non-visible neurons, no direct connections, via edges 1806, may be implemented between visible neurons 1802 and visible neurons 1804, but rather connections are routed firstly via non-visible neurons 1808, as shown in FIG. 18B. Couplings between visible and non-visible neurons may be additionally referred to herein as “layers” of a given architecture that is implemented using a thermodynamic chip, according to some embodiments.

FIGS. 19A-19C illustrate an example algorithm for learning weights and bias values to be used in a Bayesian algorithm, based on measurements taken of ancilla oscillators of an A3 ancilla thermodynamic chip coupled to a thermodynamic processor chip, according to some embodiments.

At block 1902, weights and bias values are set to an initial (or most recently updated) set of values at both the thermodynamic processor chip, such as thermodynamic chip 102, and the classical computing device, such as classical computing device 104. For example, the set of weights and biases values used in block 1902 may be an initial starting point set of values from which energy-based model weights and biases will be learned, or the set of weights and biases used in block 1902 may be an updated set of weights and bias values from a previous iteration. For example, the energy-based model may have already been partially trained via one or more prior iterations of learning and the current iteration may further train the energy-based model.

At block 1904, positions of ancilla oscillators of the A3 ancilla thermodynamic chip are initialized randomly. The momentums may also optionally be set to zero.

At block 1906, a first (or next) mini-batch of input training data may be used as data values for the current iteration of learning. Also, the visible neurons of the thermodynamic processor chip will be clamped to the respective elements of the first (or next) mini-batch.

At block 1908, the synapse oscillators (which are also on the thermodynamic processor chip with the visible neurons oscillators that will be clamped to input data in block 1910) are initialized with the initial or current weight and bias values being used in the current iteration of learning. In contrast to the visible neuron oscillators, which will remain clamped during the clamped phase evolution, the synapse oscillators are free to evolve during the clamped phase evolution after being initialized with the current weight and bias values for the current iteration of learning.

At block 1910, the visible neuron oscillators are clamped to have the values of the elements of the mini-batch selected at block 1906.

At block 1912, the synapse oscillators evolve and momentum measurements are taken of the ancilla oscillators while the visible neurons are clamped to input data. For example, at block 1914, momentum degrees of freedom of the ancilla oscillators of the A3 ancilla thermodynamic chip are measured throughout the evolution, such as shown in FIG. 11.

At block 1916 a time-averaged gradient is determined for the clamped phase. For example, the momentum measurements determined at block 1914 are used in the equations shown in FIG. 7A to determine the time-averaged gradient.

At block 1918, it is determined if there are additional mini-batches for which clamped phase evolutions and ancilla momentum measurements are to be taken. If so, then the process may revert to block 1906 and be repeated for the next mini-batch.

Next at block 1920, the ancilla oscillator of the A3 ancilla thermodynamic chip are re-initialized randomly.

Also, at block 1922, the thermodynamic processor chip is re-initialized with the current weight and bias values (for the synapse oscillators) (e.g., the same weights and bias values as used to initialize prior the clamped phase, at block 1908). The visible neuron oscillators are then allowed to evolve at block 1924 (with both the visible neuron oscillators and the synapse oscillators un-clamped). While the oscillators are evolving, momentum measurements are taken, such as in FIG. 11, at block 1926.

At block 1928, the time-averaged gradient for the un-clamped phase is calculated on the classical computing device, such as classical computing device 104. The un-clamped phase time-averaged gradient is calculated using the momentum measurements of the un-clamped evolution performed at block 1926. The time averaged gradient for the un-clamped phase can be calculated, using the momentum measurements, based on the equations shown in FIG. 7A.

At block 1930, expectation values for all pairs of weights and all pairs of biases are determined using the equations shown in FIG. 7B. For example, measurements (as shown in FIG. 7B), such as ancilla momentum measurements, may be used as inputs to simple calculations performed on classical computing device 104 to determine the expectation values of the pairs of weights and biases.

At block 1932, all components of the information matrix are determined, for example at the classical computing device 104, based on measured ancilla momentum values.

At block 1934 the Moore-Penrose inverse of the information matrix determined at block 1932 is calculated.

At block 1936, new weights and bias values are then determined using the time-averaged gradients determined at blocks 1916 and 1928, and also using the inverse of the information matrix computed at bock 1934.

At block 1938, it is determined whether a training threshold has been met, if so, the energy-based model is considered ready to perform inference, for example at block 1940. If not, the process reverts to 1902 and further training is performed to determine further updated weights and biases using another set of training data.

FIGS. 20A-20C illustrate an example algorithm for learning weights and bias values to be used in a Bayesian algorithm, based on measurements taken of ancilla oscillators of an A2 ancilla thermodynamic chip and based on measurements taken of ancilla oscillators of an A1 ancilla thermodynamic chip, both respectively coupled to a thermodynamic processor chip, according to some embodiments.

At block 2002, weights and bias values are set to an initial (or most recently updated) set of values at both the thermodynamic processor chip, such as thermodynamic chip 102, and the classical computing device, such as classical computing device 104. For example, the set of weights and biases values used in block 2002 may be an initial starting point set of values from which the energy-based model weights and biases will be learned, or the set of weights and biases used in block 2002 may be an updated set of weights and bias values from a previous iteration.

At block 2004 ancilla oscillators of an A2 ancilla thermodynamic chip are coupled to a thermodynamic processor chip. For example, the ancilla oscillators of the A2 ancilla thermodynamic chip may be coupled to the synapse oscillators of the thermodynamic processor chip using couplings 414 as shown in FIG. 4.

At block 2006, the positions of the ancilla oscillators of the A2 chip are initialized randomly. Also, the momentum degrees of freedom of the ancilla oscillator may optionally be set to zero.

At block 2008, a first (or next) mini-batch of input training data may be used as data values for the current iteration of learning. Also, the visible neurons of the thermodynamic chip will be clamped to the respective elements of the first (or next) mini-batch.

At block 2010, the synapse oscillators of the thermodynamic processor are initialized with the initial or current weight and bias values being used in the current iteration of learning. In contrast to the visible neuron oscillators, which will remain clamped during the clamped phase evolution, the synapse oscillators are free to evolve during the clamped phase evolution after being initialized with the current weight and bias values for the current iteration of learning.

At block 2012, the visible neuron oscillators are clamped to have the values of the elements of the mini-batch selected at block 2008.

At block 2014, the synapse and ancilla oscillators evolve and momentum measurements are taken of the ancilla oscillators for example, as shown in FIG. 10 or FIG. 11. For example, at block 2016, momentum measurements of the ancilla oscillators of the A2 ancilla thermodynamic chip are taken during the evolution. If the momentum evolves in a linear fashion, then measurements as shown in FIG. 10, e.g. at the beginning and at the end of the evolution of the synapse oscillators, may be taken. However, if the momentum evolution of the ancilla oscillators is non-linear, more frequent measurements, such as shown in FIG. 11 may be taken.

At block 2018 a time-averaged gradient is determined for the clamped phase. For example, the momentum measurements determined at block 2016 are used in the equations shown in FIG. 8A to determine the time-averaged gradient.

At block 2020, it is determined if there are additional mini-batches for which clamped phase evolutions and ancilla oscillator momentum measurements are to be taken. If so, then the process may revert to block 2008 and be repeated for the next mini-batch.

At block 2022, the ancilla oscillators of the A2 ancilla thermodynamic chip are coupled to the synapse oscillators of the thermodynamic processor chip, for the un-clamped phase evolution. For example, the ancilla oscillators of the A2 ancilla thermodynamic chip may be coupled to the synapse oscillators of the thermodynamic processor chip using couplings 414 as shown in FIG. 4.

At block 2024, the positions of the ancilla oscillators of the A2 chip are initialized randomly. Also, the momentum degrees of freedom of the ancilla oscillator may optionally be set to zero.

At block 2026, for the un-clamped phase evolution, the synapse oscillators of the thermodynamic processor are initialized with the initial or current weight and bias values being used in the current iteration of learning. In the un-clamped phase evolution both the neuron oscillators as well as the synapse oscillators are free to evolve after being initialized with the current weight and bias values for the current iteration of learning. Additionally, the ancilla oscillators of the A2 ancilla chip are free to evolve.

At block 2028, the synapse oscillators evolve and measurements are taken for example, as shown in FIG. 10 or FIG. 11 of the ancilla oscillators. For example, at block 2030, momentum measurements of the ancilla oscillators of the A2 ancilla thermodynamic chip are taken during the evolution. If the momentum evolves in a linear fashion, then measurements as shown in FIG. 10, e.g. at the beginning and at the end of the evolution of the synapse oscillators may be taken. However, if the momentum evolution of the ancilla oscillators is non-linear, more frequent measurements, such as shown in FIG. 11 may be taken.

At block 2032, the time-averaged gradient for the un-clamped phase is calculated on the classical computing device, such as classical computing device 104. The equations shown in FIG. 8A, as well as the measurements taken at block 2030, are used to determine the time-averaged gradients.

At block 2034, the ancilla oscillators of the A1 ancilla thermodynamic chip are coupled to the synapse oscillators of the thermodynamic processor chip, for another un-clamped phase evolution. For example, the ancilla oscillators of the A1 ancilla thermodynamic chip may be coupled to the synapse oscillators of the thermodynamic processor chip using couplings 332 as shown in FIG. 3.

At block 2036, the positions of the ancilla oscillators of the A1 chip are initialized randomly. Also, the momentum degrees of freedom of the ancilla oscillator may optionally be set to zero.

At block 2038, for the second un-clamped phase evolution (e.g. using the A1 ancilla chip), the synapse oscillators of the thermodynamic processor are initialized with the initial or current weight and bias values being used in the current iteration of learning. In the second un-clamped phase evolution both the neuron oscillators as well as the synapse oscillators are free to evolve after being initialized with the current weight and bias values for the current iteration of learning. Additionally, the ancilla oscillators of the A1 ancilla chip are free to evolve.

At block 2040, the synapse oscillators evolve and measurements are taken for example, as shown in FIG. 10 or FIG. 11. For example, at block 2042, momentum measurements of the ancilla oscillators of the A1 ancilla thermodynamic chip are taken during the evolution. If the ancilla oscillator momentums evolve in a linear fashion, then measurements as shown in FIG. 10, e.g. at the beginning and at the end of the evolution of the oscillators may be taken. However, if the momentum evolution of the ancilla oscillators is non-linear, more frequent measurements, such as shown in FIG. 11 may be taken.

At block 2044, time averaged momentum values for the A1 chip un-clamped evolution are determined using the measurements taken at block 2042.

At block 2046, the components of the information matrix are determined using the results from block 2044 and the momentum measurements from blocks 2030 and 2042 based on the equations shown in FIG. 8B.

At block 2048 the Moore-Penrose inverse of the information matrix determined at block 2046 is calculated.

At block 2050, new weights and bias values are then determined using the time-averaged gradients determined at blocks 2018 and 2032, along with the information matrix. In some embodiments, the new weights and bias values are calculated on the classical computing device 104.

At block 2052, it is determined whether a training threshold has been met, if so, the energy-based model is considered ready to perform inference, for example at block 2054. If not, the process reverts to 2002 and further training is performed using another set of training data.

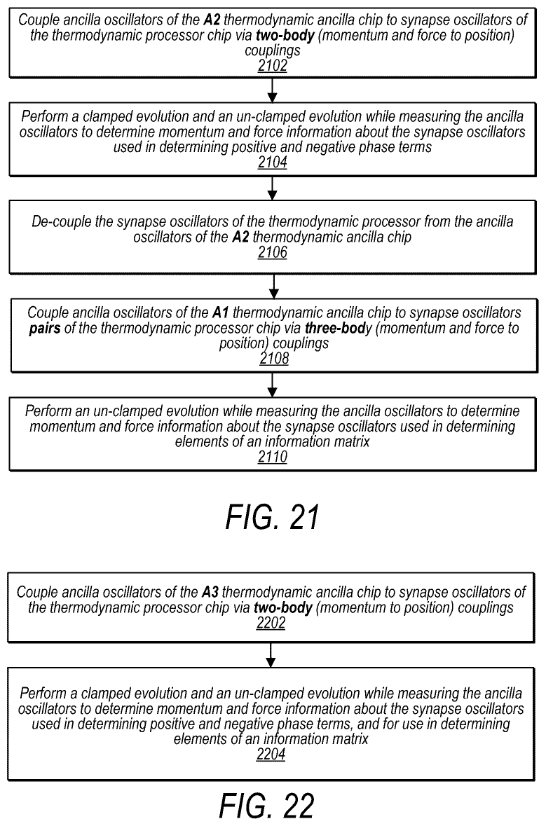

FIG. 21 illustrates a high-level overview of the technique using the A1 and A2 ancilla chips and respective couplings and de-coupling performed when using this technique, according to some embodiments.

At block 2102, ancilla oscillators of an A2 thermodynamic chip are coupled to synapse oscillators of a thermodynamic processor, for example using couplings 414 as shown in FIG. 4.

At block 2104, a clamped evolution and an un-clamped evolution are performed and momentum measurements are taken of the ancilla oscillators of the A2 thermodynamic chip that is coupled to the thermodynamic processor.

At block 2106, the A2 ancilla thermodynamic chip is de-coupled from the thermodynamic processor chip.

At block 2108, ancilla oscillators of the A1 ancilla thermodynamic chip are coupled to synapse oscillators of the thermodynamic processor chip, using couplings 332 as shown in FIG. 3B.

At block 2110, an un-clamped evolution is performed and momentum measurements of the ancilla oscillators of the A1 thermodynamic chip are taken.

The measurements of the clamped and un-clamped phases measured using the A2 ancilla chip at block 2104 and the measurements of the un-clamped phase measured using the A1 ancilla chip at block 2110 may be used to determine updated weight and bias values using the equations shown in FIGS. 8A and 8B.

FIG. 22 illustrates a high-level overview of the technique using the A3 ancilla chip, according to some embodiments.

At block 2202 ancilla oscillators of the A3 ancilla thermodynamic chip are coupled to synapse oscillators of the thermodynamic process using couplings 214 as shown in FIG. 2B.

At block 2204 clamped and un-clamped evolutions are performed and momentum measurements of ancilla oscillators of the A3 thermodynamic chip are taken. The measurements of the clamped and un-clamped evolutions may be used to determine updated weight and bias values using the equations shown in FIGS. 7A and 7B.

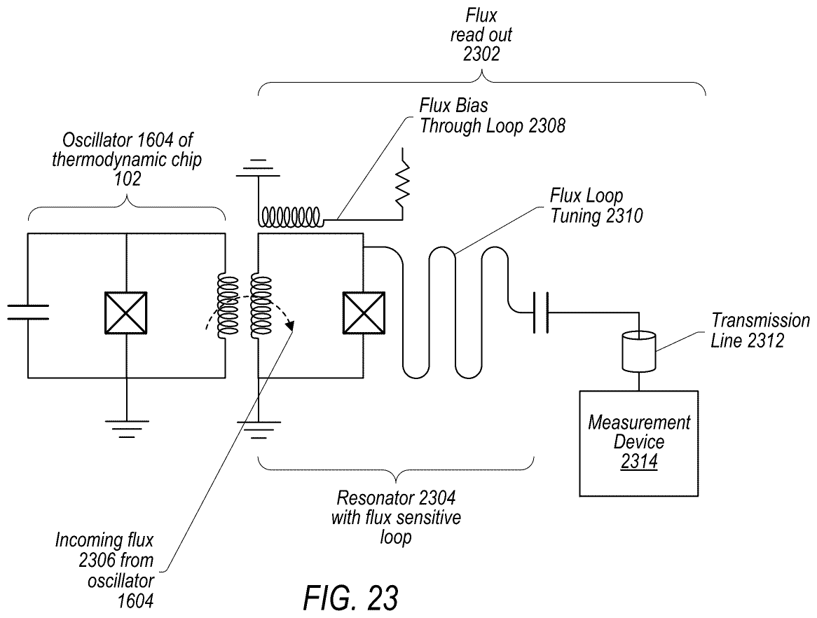

FIG. 23 illustrates an example apparatus for measuring positions of oscillators of a thermodynamic chip using a flux read-out device, according to some embodiments.

In some embodiments, a resonator with a flux sensitive loop, such as resonator 2304 of flux readout apparatus 2302 may be used to measure flux and therefore position of an oscillator 1504 of thermodynamic chip 102. Note that flux is the analog of position for the oscillators used in thermodynamic chip 102. The flux of oscillator 1504 is measured by flux readout device 2302. For example, if the inductance of oscillator 1504 changes, it will also cause a change in the inductance of resonator 2304. This in turn causes a change in the frequency at which resonator 2304 resonates. In some embodiments, measurement device 2314 detects such changes in resonator frequency of resonator 2304 by sending a signal wave through the resonator 2304. The response wave that can be measured at measurement device 2314, will be altered due to the change in resonator frequency of resonator 2304, which can be measured and calibrated to measure the flux of oscillator 1504, and therefore the position of its corresponding neuron, synapse, or ancilla that is coded using that oscillator.

More specifically, in some embodiments, incoming flux 2306 from resonator 1504 is sensed by the inductor of resonator 2304, wherein flux tuning loop 2310 is used to tune the flux sensed by resonator 2304. Flux bias 2308 also biases the flux to flow through resonator 2304 towards transmission line 2312. In some embodiments, transmission line 2312 may carry the signal outside of a dilution refrigerator, such as dilution refrigerator 1202 shown in FIG. 12. Also, in some embodiments, transmission line 2312 may carry the signal to a classical computing device located within the dilution refrigerator, such as is shown for dilution refrigerator 1302 in FIG. 13. Measurement device 2314 may then be used to measure the signal representing the flux and may provide a flux measurement value and/or provide a position measurement value.

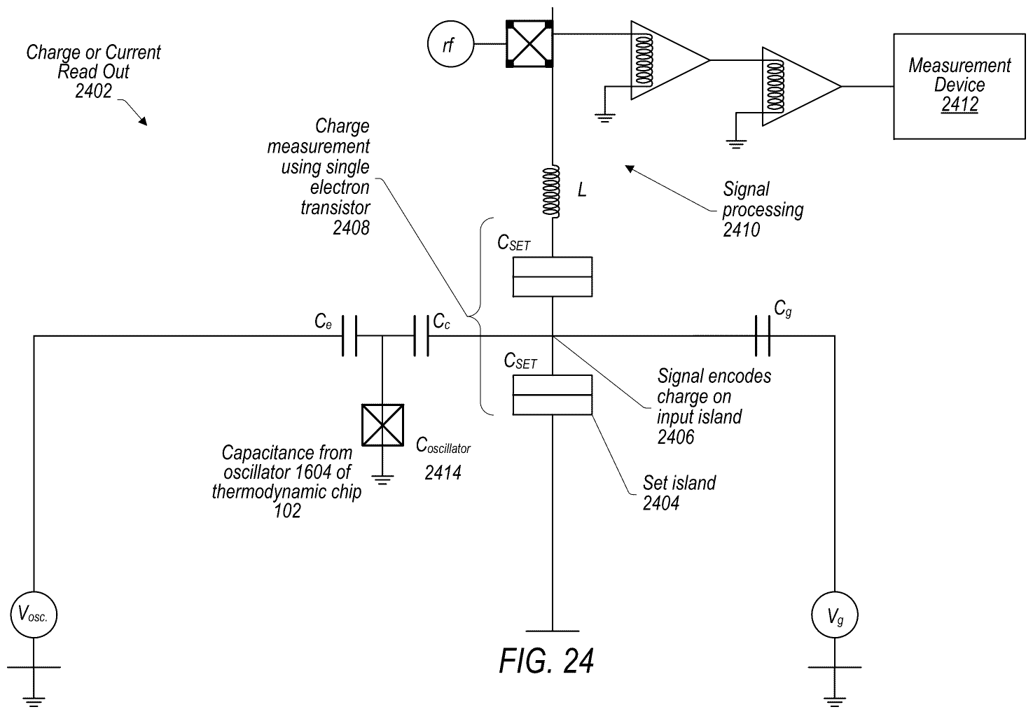

FIG. 24 illustrates an example apparatus for measuring momentums of oscillators of a thermodynamic chip using a charge read-out device, according to some embodiments.

As mentioned in the discussion of FIG. 23, flux of an oscillator of the thermodynamic chip corresponds to position. In a similar manner, a charge measurement of an oscillator corresponds to momentum. In some embodiments, a charge or current read out circuit, such as charge or current read out circuit 2402, may be used to measure charge of a given oscillator of the thermodynamic chip 102 or thermodynamic chip 106. In such an arrangement, the oscillator 1504 of thermodynamic chip 102 or 106 is represented by oscillator 2014, which is coupled to a SET island 2004 that appears as a small superconducting island from the perspective of the charge or current read out circuit 2402. For example, the charge or current read out circuit 2402 includes capacitances Ce, Cc, and Cg which are connected in the lower portion of the charge or current read out circuit 2402 as shown in FIG. 24. The Cg capacitance along with the voltage Vg is used to bias the charge on the SET island. The Ce capacitance along with the voltage V_{oscillator}, is used to bias the charge of the oscillator 1504, the Cc capacitance is the capacitance between the SET island 2404 and the oscillator 1504. The Cₛₑₜ island (e.g. SET island 2404) is used to measure the charge of the oscillator 1504 with capacitance C_{osciniator}, since the SET properties (2408) are sensitive to the charge on the SET island 2404, which is coupled to the oscillator charge. The amplifiers (cold and warm) and radio frequency signal source of signal processing 2410 are used to send the measured signal indicating the charge of the oscillator 1504 to a measurement device 2412, which may be a classical computing device, such as classical computing device 104.

### Illustrative Computer System

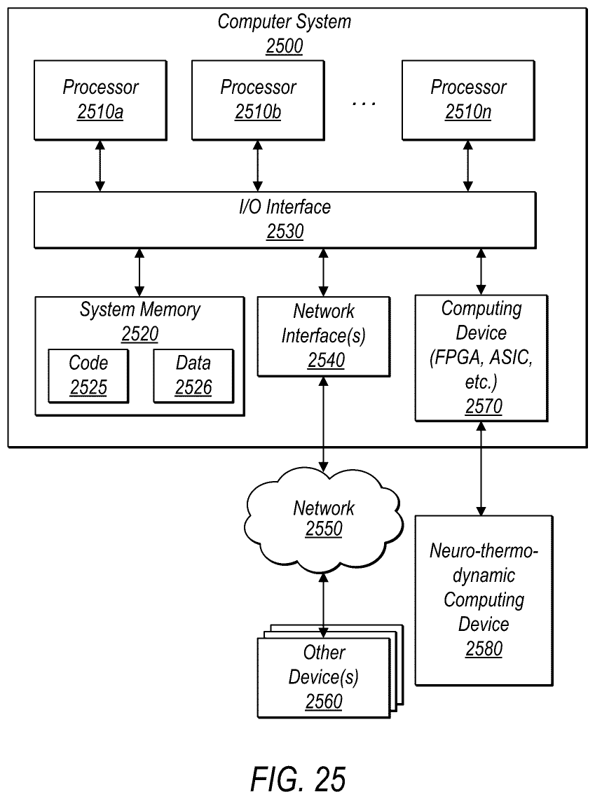

FIG. 25 is a block diagram illustrating an example computer system that may be used in at least some embodiments. In some embodiments, the computing system shown in FIG. 25 may be used, at least in part, to implement any of the techniques described above in FIGS. 1-24. Furthermore, computer system 2500 may be configured to interact and/or interface with self-learning neuro-thermodynamic computing device 2580, according to some embodiments.

In the illustrated embodiment, computer system 2500 includes one or more processors 2510 coupled to a system memory 2520 (which may comprise both non-volatile and volatile memory modules) via an input/output (I/O) interface 2530. Computer system 2500 further includes a network interface 2540 coupled to I/O interface 2530. Classical computing functions may be performed on a classical computer system, such as computing computer system 2500.

Additionally, computer system 2500 includes computing device 2570 coupled to thermodynamic chip 2580. In some embodiments, computing device 2570 may be a field programmable gate array (FPGA), application specific integrated circuit (ASIC) or other suitable processing unit. In some embodiments, computing device 2570 may be a similar computing device as described in FIGS. 1-24, such as classical computing devices 104. In some embodiments, neuro thermodynamic computing device 2580 may be a similar neuro thermodynamic computing device as described in FIGS. 1-24, such as neuro thermodynamic computing devices implemented using thermodynamic chip 102.

In various embodiments, computer system 2500 may be a uniprocessor system including one processor 2510, or a multiprocessor system including several processors 2510 (e.g., two, four, eight, or another suitable number). Processors 2510 may be any suitable processors capable of executing instructions. For example, in various embodiments, processors 2510 may be general-purpose or embedded processors implementing any of a variety of instruction set architectures (ISAs), such as the x86, PowerPC, SPARC, or MIPS ISAs, or any other suitable ISA. In multiprocessor systems, each of processors 2510 may commonly, but not necessarily, implement the same ISA. In some implementations, graphics processing units (GPUs) may be used instead of, or in addition to, conventional processors.

System memory 2520 may be configured to store instructions and data accessible by processor(s) 2510. In at least some embodiments, the system memory 2520 may comprise both volatile and non-volatile portions; in other embodiments, only volatile memory may be used. In various embodiments, the volatile portion of system memory 2520 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 2520 as code 2525 and data 2526.

In some embodiments, I/O interface 2530 may be configured to coordinate I/O traffic between processor 2510, system memory 2520, computing device 2570, and any peripheral devices in the computer system, including network interface 2540 or other peripheral interfaces such as various types of persistent and/or volatile storage devices. In some embodiments, I/O interface 2530 may perform any necessary protocol, timing or other data transformations to convert data signals from one component (e.g., system memory 2520) into a format suitable for use by another component (e.g., processor 2510). In some embodiments, I/O interface 2530 may include support for devices attached through various types of peripheral buses, such as a variant of the Peripheral Component Interconnect (PCI) bus standard or the Universal Serial Bus (USB) standard, for example. In some embodiments, the function of I/O interface 2530 may be split into two or more separate components, such as a north bridge and a south bridge, for example. Also, in some embodiments some or all of the functionality of I/O interface 2530, such as an interface to system memory 2520, may be incorporated directly into processor 2510.

Network interface 2540 may be configured to allow data to be exchanged between computing device 2500 and other devices 2560 attached to a network or networks 2550, such as other computer systems or devices. In various embodiments, network interface 2540 may support communication via any suitable wired or wireless general data networks, such as types of Ethernet network, for example. Additionally, network interface 2540 may support communication via telecommunications/telephony networks such as analog voice networks or digital fiber communications networks, via storage area networks such as Fibre Channel SANs, or via any other suitable type of network and/or protocol.

In some embodiments, system memory 2520 may represent one embodiment of a computer-accessible medium configured to store at least a subset of program instructions and data used for implementing the methods and apparatus discussed in the context of FIG. 1 through FIG. 24. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 2500 via I/O interface 2530. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 2500 as system memory 2520 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 2540. Portions or all of multiple computing devices such as that illustrated in FIG. 25 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and the Appendix below and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description and the Appendix below is to be regarded in an illustrative rather than a restrictive sense.

What is claimed is:

1. A system, comprising:
a first thermodynamic chip comprising oscillators configured to be coupled with one another in one or more configurations that correspond to one or more engineered Hamiltonians, wherein:
a first set of the oscillators of the first thermodynamic chip represent values of visible neurons; and
a second set of the oscillators of the first thermodynamic chip represent synapse values;
a second thermodynamic chip comprising ancilla oscillators configured to be coupled to the second set of oscillators of the first thermodynamic chip; and
one or more classical computing devices coupled to the second thermodynamic chip, wherein the one or more classical computing devices are configured to:
receive, a first set of measurements comprising measurements of the ancilla oscillators of the second thermodynamic chip, wherein the first set of measurements are performed subsequent to one or more evolutions of the second set of oscillators of the first thermodynamic chip and subsequent to the ancilla oscillators of the second thermodynamic chip being coupled to the second set of oscillators of the first thermodynamic chip, wherein the first set of the oscillators of the first thermodynamic chip were clamped to input data during the one or more evolutions;
receive, subsequent to an additional evolution of the first thermodynamic chip, a second set of measurements of the ancilla oscillators of the second thermodynamic chip, wherein the second set of measurements are performed subsequent to the additional evolution and subsequent to the ancilla oscillators of the second thermodynamic chip being coupled to the second set of oscillators of the first thermodynamic chip, wherein the first set of oscillators of the first thermodynamic chip were not clamped during the additional evolution;
determine a gradient value for use in computing updated bias and weighting values based on the first and second sets of measurements; and
determine the updated bias and weighting values using the determined gradient value.

2. The system of claim 1, wherein the first set of oscillators of the first thermodynamic chip further comprises oscillators that represent hidden neurons, and wherein at least some of the second set of oscillators represent synapse values for the hidden neurons.

3. The system of claim 1, wherein the one or more classical computing devices are configured to:
determine a positive phase term based on the first set of measurements;
determine a negative phase term based on the second set of measurements, wherein the gradient value is determined based on the positive phase term and the negative phase term; and
determine an information matrix for use in computing the updated bias and weighting values based on the second set of measurements, wherein the first and second set of measurements include a plurality of measurements taken during the respective evolutions on a time-scale faster than a time scale at which the second set of oscillators representing the synapse values reach thermal equilibrium,
wherein the updated bias and weighting values are further determined using the information matrix.

4. The system of claim 3, wherein the ancilla oscillators of the second thermodynamic chip remain coupled to the second set of oscillators of the first thermodynamic chip, when performing the first and second sets of measurements.

5. The system of claim 3, wherein respective ones of the ancilla oscillators of the second thermodynamic chip are coupled to respective ones of the second set of oscillators of the first thermodynamic chip via respective momentum-to-position couplings,
wherein, a momentum value of a given oscillator of the second set of oscillators of the first thermodynamic chip corresponds, via its respective momentum-to-position coupling, to a position of its corresponding ancilla oscillator of the second thermodynamic chip.

6. The system of claim 5, wherein the momentum-to-position couplings are implemented as charge-to-flux couplings, wherein a charge value of an oscillator of the first thermodynamic chip is coupled to a flux value of its corresponding ancilla oscillator of the second thermodynamic chip.

7. The system of claim 1, wherein the first set of measurements performed subsequent to the one or more evolutions comprises:
measurements of the ancilla oscillators representing synapse values subsequent to a first evolution of the first thermodynamic chip while clamped to a first batch of the input data; and
additional measurements of the ancilla oscillators representing additional synapse values subsequent to one or more additional evolutions of the first thermodynamic chip while clamped to one or more additional batches of the input data.

8. The system of claim 1, wherein masses assigned to the oscillators of the first thermodynamic chip representing the synapse values are greater masses than masses assigned to the first set of oscillators of the first thermodynamic chip representing the visible neurons, wherein, for respective ones of the oscillators, the oscillator's mass is represented by magnetic flux squared times capacitance (m=ϕ₀²C).

9. The system of claim 1, wherein masses assigned to the ancilla oscillators of the second thermodynamic chip are greater than the values of the second set of oscillators that are transferred to the ancilla oscillators and measured during the first and second sets of measurements.

10. The system of claim 1, wherein the one or more classical computing devices are further configured to:
receive, subsequent to another evolution, a third set of measurements of the ancilla oscillators of the second thermodynamic chip, wherein:
the third set of measurements are performed subsequent to the other evolution,
the ancilla oscillators of the second thermodynamic chip and the second set of oscillators of the first thermodynamic chip were coupled to one another during the other evolution, and
the first set of oscillators of the first thermodynamic chip were not clamped to the input data during the other evolution; or
receive, subsequent to other evolution, the third set of measurements of the ancilla oscillators of the second thermodynamic chip, wherein:
the third set of measurements are performed subsequent to the other evolution,
the ancilla oscillators of the second thermodynamic chip and a second set of oscillators of a third thermodynamic chip were coupled to one another during the other evolution, and
a first set of oscillators of the third thermodynamic chip were not clamped to the input data during the other evolution.

11. The system of claim 10, wherein the one or more classical computing devices are configured to:
determine a positive phase term based on the first set of measurements;
determine a negative phase term based on the second set of measurements, wherein the gradient value is determined based on the positive phase term and the negative phase term; and
determine an information matrix for use in computing the updated bias and weighting values based on the third set of measurements,
wherein the updated bias and weighting values are further determined using the information matrix.

12. The system of claim 11, wherein to perform the first and second sets of measurements respective ones of the ancilla oscillators of the second thermodynamic chip are coupled to respective ones of the second set of oscillators of the first thermodynamic chip via respective two-body-momentum-and-force-to-position couplings,
wherein, a momentum value and a force value of a given oscillator of the second set of oscillators of the first thermodynamic chip corresponds, via its respective two-body-momentum-and-force-to-position coupling, to a position of its corresponding ancilla oscillator of the second thermodynamic chip.

13. The system of claim 11, wherein to perform the third set of measurements respective ones of the ancilla oscillators of the second thermodynamic chip are coupled to respective sets of two oscillators of the second set of oscillators of the first or third thermodynamic chips via respective three-body-momentum-and-force-to-position couplings,
wherein, respective momentum values and respective force values of a given set of two of the oscillators of the second set of oscillators of the first or third thermodynamic chips correspond, via their respective three-body-momentum-and-force-to-position coupling, to a position of their corresponding ancilla oscillator of the second thermodynamic chip.

14. The system of claim 13, wherein the one or more classical computing devices coupled to the second thermodynamic chip are further configured to:
cause the ancilla oscillators of the second thermodynamic chip to be coupled to the second set of oscillators of the first or third thermodynamic chips to transfer synapse value information from the second set of oscillators of the first or third thermodynamic chips to the ancilla oscillators of the second thermodynamic chip;
decouple the ancilla oscillators of the second thermodynamic chip from the second set of oscillators of the first or third thermodynamic chips; and
cause measurements to be taken of the ancilla oscillators of the second thermodynamic chip, while decoupled from the second set of oscillators of the first or third thermodynamic chips.

15. A method of training a thermodynamic chip, the method comprising:
receiving, a first set of measurements of ancilla oscillators of a second thermodynamic chip coupled to synapse oscillators of a first thermodynamic chip, wherein the first set of measurements are performed subsequent to one or more evolutions of the synapse oscillators of the first thermodynamic chip and subsequent to the ancilla oscillators of the second thermodynamic chip being coupled to the synapse oscillators of the first thermodynamic chip, wherein visible neuron oscillators of the first thermodynamic chip were clamped to input data during the one or more evolutions;
receiving, subsequent to an additional evolution of the first thermodynamic chip, a second set of measurements of the ancilla oscillators of the second thermodynamic chip, wherein the second set of measurements are performed subsequent to the additional evolution and subsequent to the ancilla oscillators of the second thermodynamic chip being coupled to the synapse oscillators of the first thermodynamic chip, wherein the visible neuron oscillators of the first thermodynamic chip were not clamped during the additional evolution;
determining a gradient value for use in computing updated bias and weighting values based on the first and second sets of measurements; and
determining the updated bias and weighting values using the determined gradient value.

16. The method of claim 15, wherein the first thermodynamic chip further comprises hidden neuron oscillators that are not clamped to input data.

17. The method of claim 15, further comprising:
determining a positive phase term based on the first set of measurements;
determining a negative phase term based on the second set of measurements, wherein the gradient value is determined based on the positive phase term and the negative phase term; and
determining an information matrix for use in computing the updated bias and weighting values based on the first and second set of measurements, wherein the first and second set of measurements include a plurality of measurements taken during the respective evolutions on a time-scale faster than a time scale at which the synapse oscillators representing the synapse values reach thermal equilibrium,
wherein the updated bias and weighting values are further determined using the information matrix.

18. The method of claim 17, wherein respective ones of the ancilla oscillators of the second thermodynamic chip are coupled to respective ones of the second set of oscillators of the first thermodynamic chip via respective momentum-to-position couplings.

19. The method of claim 18, wherein the momentum-to-position couplings are implemented as charge-to-flux couplings, wherein a charge value of a synapse oscillator of the first thermodynamic chip is coupled to a flux value of its corresponding ancilla oscillator of the second thermodynamic chip.

20. The method of claim 17, further comprising:
training the weights and bias values using a Bayesian learning algorithm that uses a natural gradient descent optimization algorithm, wherein the training comprises multiple iterations of receiving the first and second sets of measurements, determining the gradient value and the information matrix, and determining the updated weights and bias values.

21. The method of claim 15, further comprising:
training the weights and bias values using a Bayesian learning algorithm that uses a stochastic gradient optimization algorithm, wherein the training comprises multiple iterations of said receiving the first and second sets of measurements, said determining the gradient, and said determining the updated the weights and bias values.

22. One or more non-transitory, computer-readable, storage media storing program instructions that, when executed on or across one or more processors, cause the one or more processors to:
receive, a first set of measurements of ancilla oscillators of a second thermodynamic chip coupled to synapse oscillators of a first thermodynamic chip, wherein the first set of measurements are performed subsequent to one or more evolutions of the synapse oscillators of the first thermodynamic chip and subsequent to the ancilla oscillators of the second thermodynamic chip being coupled to the synapse oscillators of the first thermodynamic chip, wherein visible neuron oscillators of the first thermodynamic chip were clamped to input data during the one or more evolutions;
receive, subsequent to an additional evolution of the first thermodynamic chip, a second set of measurements of the ancilla oscillators of the second thermodynamic chip, wherein the second set of measurements are performed subsequent to the additional evolution and subsequent to the ancilla oscillators of the second thermodynamic chip being coupled to the synapse oscillators of the first thermodynamic chip, wherein the visible neuron oscillators of the first thermodynamic chip were not clamped during the additional evolution;
determine a gradient value for use in computing updated bias and weighting values based on the first and second sets of measurements; and
determine the updated bias and weighting values using the determined gradient value.
